(19) United States
(12) Patent Application Publication
(10) Pub. No.: US 2026/0289260 A1
(43) Pub. Date: Sep. 24, 2026

(54) SYSTEM

(71) Applicant: SoftBank Group Corp., Tokyo (JP)

(72) Inventor: Toshihide OHASHI, Tokyo (JP)

(73) Assignee: SoftBank Group Corp., Tokyo (JP)

(21) Appl. No.: 19/564,292

(22) Filed: Mar. 12, 2026

(30) Foreign Application Priority Data
Mar. 19, 2025 (JP) 2025-044952

(51) Int. Cl. G06N 3/0475; G06F 3/01; G06F 16/3332; G06F 40/186; G06F 40/205; G06F 40/284; G10L 15/26

(52) U.S. Cl. CPC G06N 3/0475; G06F 3/011; G06F 16/3334; G06F 40/186; G06F 40/205; G06F 40/284; G10L 15/26; G06F 2203/011

(57) ABSTRACT

A system includes a processor that is configured to: generate a prompt to instruct a user, via an information processing apparatus, to select a classification item, generate a prompt to instruct presentation of a plurality of questions related to the classification item based on a selection made by the user, and generate a prompt to instruct processing of answer data provided by the user and calculation of conditions and fees for a plurality of services based on the answer data.

### CROSS-REFERENCE TO RELATED APPLICATION

This application is based on and claims priority under 35 USC 119 from Japanese Patent Application No. 2025-044952 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional service selection and contracting systems, a user is often required to manually search for relevant categories, manually identify applicable questions, and manually input extensive answer data in order to obtain conditions and fees for various services. This manual process imposes a significant cognitive and operational burden on the user, especially when the number of services and parameters is large, and often results in errors or incomplete information. Furthermore, conventional systems frequently lack adequate support for foreign languages, making it difficult for foreign users to utilize the service in their native language. In addition, users with visual impairments or users whose hands are not free may find it difficult to operate systems that rely solely on manual text input and graphical user interfaces. Accordingly, there is a need for a system that can simplify and guide the user's interaction by automatically prompting for category selection, question presentation, and answer-based calculation of service conditions and fees, while also providing improved accessibility through foreign language support and voice recognition capabilities.

### SUMMARY

In order to solve at least part of the aforementioned problems, the present invention provides a system comprising a processor, wherein the processor is configured to generate a prompt to instruct a user, via an information processing apparatus, to select a classification item; generate a prompt to instruct presentation of a plurality of questions related to the classification item based on a selection made by the user; and generate a prompt to instruct processing of answer data provided by the user and calculation of conditions and fees for a plurality of services based on the answer data. By guiding the user stepwise through classification item selection, question presentation, and answer submission, the system reduces the user's cognitive load and automates the derivation of appropriate service options. In some embodiments, the processor is further configured to generate a prompt to instruct support for a foreign language, thereby enabling presentation of prompts and questions in a language selected by the user and improving usability for foreign users. In some embodiments, the processor is further configured to generate a prompt to instruct incorporation of voice recognition, thereby allowing users to provide answers by voice instead of manual text input and improving accessibility for visually impaired users and users who cannot easily operate input devices.

The term “system” refers to an assemblage of hardware components, software components, or a combination thereof, configured to execute the processing operations described in the claims.

The term “processor” refers to one or more hardware processing units, such as a central processing unit (CPU), a microprocessor, a microcontroller, a digital signal processor (DSP), or a specialized processing circuit, configured to execute instructions that cause the system to perform specified functions.

The term “information processing apparatus” refers to any device or terminal capable of communicating with the processor and presenting prompts or questions to a user, including but not limited to a personal computer, a smartphone, a tablet, a kiosk terminal, or a similar electronic device.

The term “prompt” refers to information, including but not limited to display data, audio output, or control signals, generated by the processor to cause the information processing apparatus to guide or instruct a user or to control the presentation of information to the user.

The term “classification item” refers to a category, type, or class of services or subjects that can be selected by a user as an initial basis for narrowing down or organizing subsequent questions and service options.

The term “plurality of questions” refers to two or more interrogative items that are associated with a selected classification item and that are presented to the user to obtain answer data relevant to the calculation of service conditions and fees.

The term “answer data” refers to information representing one or more responses provided by the user to the plurality of questions, including numerical values, text inputs, selections, or other forms of user input.

The term “conditions” refers to service-related parameters or attributes, such as data limits, speed limits, coverage ranges, contract durations, eligibility criteria, or other terms under which a service is provided.

The term “fees” refers to monetary amounts or cost-related parameters associated with the provision of one or more services, including but not limited to one-time charges, recurring charges, and usage-based charges.

The term “services” refers to offerings provided to the user, including but not limited to telecommunication services, financial services, insurance services, or other commercial or informational services for which conditions and fees can be calculated.

The term “foreign language” refers to any language different from a default or primary language of the system, and is intended to encompass one or more alternative natural languages that can be selected for displaying prompts, questions, and related information.

The term “voice recognition” refers to a function or process by which spoken input from the user is analyzed and converted into text or control information that can be used as answer data or as an input to the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

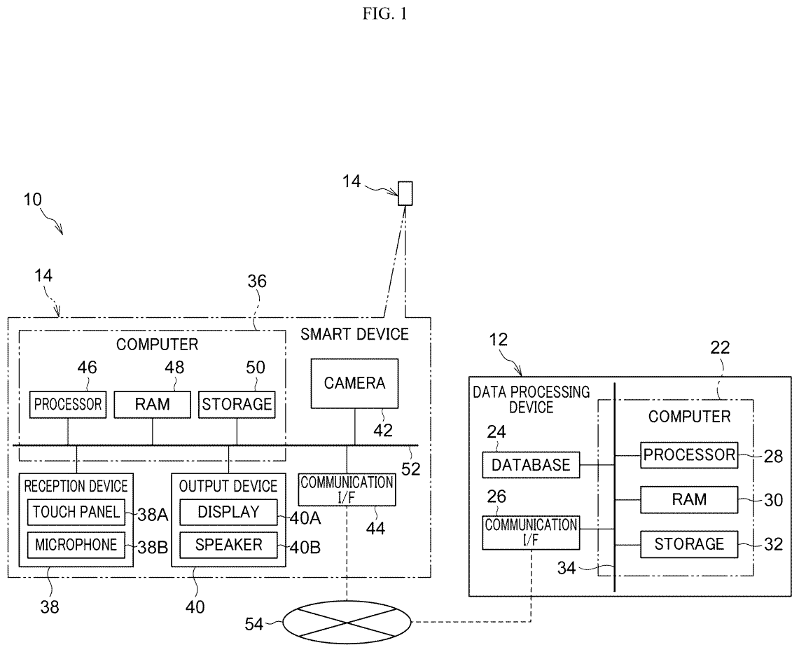

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

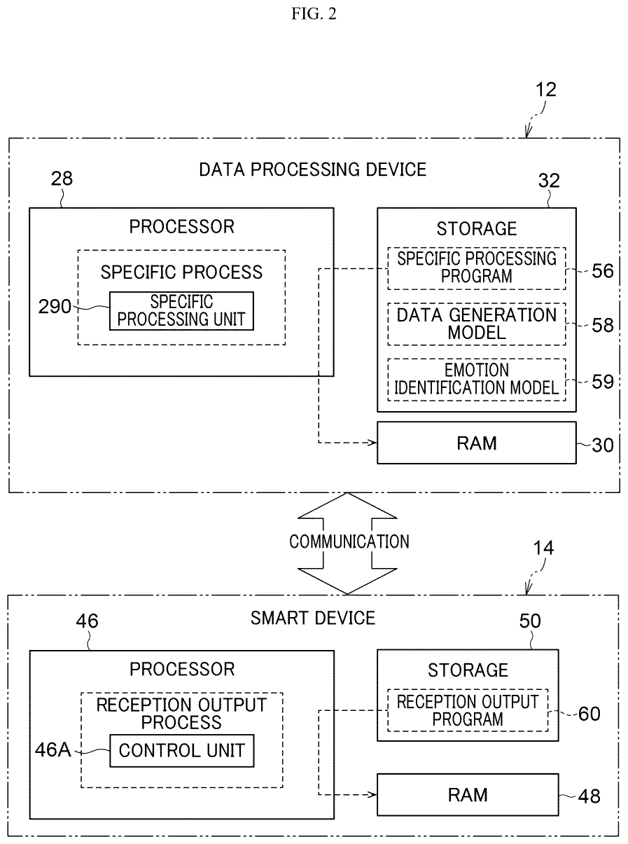

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional service recommendation systems implemented on information processing platforms generally rely on static questionnaires and rule-based filtering engines. In many such systems, a fixed set of questions is hard-coded into application logic, and user responses are processed by ad hoc scripts or monolithic server code. This architecture leads to several technical problems in computer operation.

First, when the number of service options and parameters increases, the server-side logic for managing questions and evaluating responses becomes complex and inefficient. The processor must traverse large, unstructured code paths and data structures, resulting in increased processing time, higher memory consumption, and reduced scalability. In particular, when multiple categories of services are handled in a single application instance, the absence of a structured, tabular data-processing layer causes redundant computations and inefficient data access patterns.

Second, the generation and presentation of questions and results are often tightly coupled to the user interface layer. Because the server directly embeds presentation logic into application code, any change to questions, languages, or output formats requires modification and redeployment of program modules. This coupling reduces maintainability, impedes dynamic reconfiguration at runtime, and prevents efficient reuse of processing components for different terminals or contexts. The underlying computing resources are therefore used in a non-optimal manner.

Third, most existing systems are not designed to systematically integrate a generative AI model into the server-side processing pipeline. Where such models are used, they are typically invoked in an ad hoc fashion, for example by manually composing prompts and post-processing outputs at the application layer. This lack of a standardized mechanism for constructing prompt sentences from machine-readable user response data and service candidate data leads to inconsistent quality of generated explanations, additional processing overhead, and difficulty in controlling latency and resource allocation on the server. The computing platform cannot efficiently orchestrate interaction between structured data processing and generative AI inference.

Fourth, multilingual support and voice-based input are commonly implemented as add-on features at the user interface layer, rather than as integrated parts of the core data-processing pipeline. As a result, text in different languages and voice-recognition results are handled by disparate modules without a unified representation of guidance information, inquiry information, and explanation information. This fragmentation forces the processor to perform repeated conversions and duplicate data management operations, increasing the load on memory subsystems and inter-module communication, and degrading overall system performance and reliability.

Accordingly, there is a need for a computer-implemented system that improves the way a processor: (i) acquires and structures user classification information and response information via a terminal; (ii) processes such information by a tabular data-processing layer to compute service condition information and fee information; (iii) formulates standardized prompt sentences for a generative AI model based on machine-readable data structures; and (iv) generates structured documents for output using a template processing mechanism, while also supporting multilingual character information and voice-derived response information. Such a system should improve the efficiency, scalability, and modularity of server-side processing, reduce redundancy in data handling, and enable more consistent and controllable integration of generative AI functionality in a production computing environment.

The specific processing by the specific processing unit 290 of the data processing device 12 in Example 1 is realized by the following means.

The present invention provides a server comprising a processor configured to control communication with a terminal apparatus, to cause the terminal apparatus to display guidance information that enables a user to select classification information, to receive selection information including the classification information from the terminal apparatus, and to extract, based on stored information or learned information, a plurality of inquiry information items associated with the classification information and generate guidance information to cause the plurality of inquiry information items to be presented by the terminal apparatus; the processor being further configured to receive response information to the plurality of inquiry information items from the terminal apparatus, to aggregate and evaluate the response information by using tabular data-processing software so as to compute condition information and fee information of a plurality of service information items and extract candidate service information, to construct a prompt sentence including at least the classification information, the response information and the candidate service information, to transmit the prompt sentence to a generative AI model and obtain explanation information generated by the generative AI model, to construct result information by associating the explanation information with the candidate service information, and to convert the result information into a structured document by using template processing software and transmit the structured document to the terminal apparatus for display. This enables an improvement in the operation of the computer system by modularizing user interaction, structured data computation, generative AI interaction, and document generation, thereby reducing processing redundancy, improving scalability and responsiveness of server-side processing, and providing a unified mechanism for multilingual and voice-derived input handling within a single, efficiently orchestrated processing pipeline.

The term “system” refers to an arrangement of one or more hardware devices and software components that cooperate to execute information processing, including at least a server-side processor and a terminal apparatus connected via a communication network.

The term “processor” refers to one or more hardware logic circuits, such as a central processing unit or processing core, configured to execute instructions of a computer program and thereby implement the described functions.

The term “terminal apparatus” refers to an information processing device operated by a user, such as a general-purpose computing device having a display, an input interface, and a communication interface, capable of exchanging data with the server.

The term “display screen” refers to a visual output unit of the terminal apparatus, such as a liquid crystal display, an organic light-emitting diode display, or an equivalent display device, on which graphical user interfaces and information are presented.

The term “display unit” refers to a hardware component of the terminal apparatus or the server-side environment that outputs visual information to a user, including but not limited to a monitor, a touch panel, or a projector.

The term “guidance information” refers to data representing user interface elements, messages, or instructions that, when rendered on the terminal apparatus, prompt or guide the user to perform a specific action, such as selecting classification information or entering responses.

The term “classification information” refers to data indicating a category, class, or type of service or subject matter, which serves as a basis for selecting relevant inquiry information items and subsequently filtering service information.

The term “selection information” refers to data transmitted from the terminal apparatus to the processor that indicates which classification information or option has been chosen by the user from among multiple available alternatives.

The term “stored information” refers to data that has been persistently recorded in a storage medium accessible by the processor, such as a database, a file system, or a memory device, and that can be referenced for extracting inquiry information or service information.

The term “learned information” refers to data structures, parameters, or models obtained as a result of machine learning or other training processes, which the processor can use to determine or adapt inquiry information or other processing behavior.

The term “inquiry information” refers to data representing one or more questions, prompts, or requests for input that are presented to the user in order to obtain response information regarding user needs, preferences, or conditions.

The term “response information” refers to data representing user-provided answers or inputs to the inquiry information, including values, selections, or text entered or otherwise supplied via the terminal apparatus.

The term “service information” refers to data describing one or more services or service plans, including associated parameters such as available features, conditions of use, and price-related attributes.

The term “service information groups” refers to a collection or set of multiple service information items that are stored and processed together for the purpose of selecting one or more candidate service information items.

The term “condition information” refers to data representing conditions or attributes associated with a service, such as usage limits, contract duration, eligibility criteria, or other non-price parameters.

The term “fee information” refers to data representing monetary amounts or cost-related attributes associated with a service, such as monthly charges, initial fees, discounts, or total cost over a defined period.

The term “candidate service information” refers to one or more selected service information items extracted from the service information groups based on the response information, the condition information, and the fee information as determined by the processor.

The term “tabular data-processing software” refers to general-purpose software or a software library capable of handling data in a structured, table-like form, performing operations such as filtering, aggregation, calculation, and sorting on multiple records and fields.

The term “generative AI model” refers to a trained information processing model that receives an input including a prompt sentence and automatically generates output information, such as natural language text, based on learned patterns from training data.

The term “prompt sentence” refers to a structured input text or data sequence transmitted to the generative AI model, which includes elements such as classification information, response information, and candidate service information, and that instructs the generative AI model on what information to generate.

The term “explanation information” refers to data generated, at least in part, by the generative AI model, that describes, interprets, or justifies the candidate service information in natural language or another human-readable form.

The term “result information” refers to a data structure constructed by the processor that associates candidate service information with corresponding explanation information and optionally other related data for output to the terminal apparatus.

The term “template processing software” refers to general-purpose software or a software library configured to combine template documents with variable data, so as to generate structured documents such as marked-up pages or formatted text outputs.

The term “structured document” refers to an output document with a defined structural format, such as a markup-based document or a layout-defining data structure, in which portions of the document are determined by template rules and populated with result information.

The term “character information” refers to data representing textual content encoded in one or more character encodings, which may correspond to different language types and may be displayed on the terminal apparatus.

The term “language type” refers to a classification of natural languages or language-specific formats, such as a particular human language or locale, used to determine which character information is to be presented to the user.

The term “voice acquisition apparatus” refers to hardware configured to capture audio signals corresponding to user speech, such as a microphone or an audio input device, and to provide the captured signals to the processor or a connected module.

The term “voice analysis software” refers to software or a software library capable of processing audio signals representing user speech to recognize and convert the speech into character information or other structured data usable as response information.

In one embodiment, a server implements the claimed system by executing a computer program on generic computing hardware. The server uses at least one central processing unit, a main memory, a non-volatile storage device, and a network interface that communicates with a terminal through a packet-based network. The server executes an application program on an operating system and uses a web application framework, a tabular data-processing library, a template engine, and a generative AI model access library. In a concrete configuration, the server uses a framework such as a web framework implemented in a high-level language, a data-processing library such as a table-oriented analysis library, a template engine such as a text-based markup template engine, and an HTTP client library for calling an external generative AI model service. The server stores service information groups and inquiry information in a relational database management system or in structured files such as comma-separated value files and structured text files.

The terminal operates as a client device having a processor, a display unit, an input interface, and a communication interface. The terminal executes a web browser or an equivalent application capable of rendering markup documents received from the server and transmitting user input events to the server via a network protocol. The terminal may be realized by a smartphone, a tablet computer, a notebook computer, or a desktop workstation. The terminal decodes markup and style information from the server and displays guidance information, inquiry information, candidate service information, and explanation information on the display screen. The terminal receives user operations via a touch sensor, a keyboard, a pointing device, or a microphone.

The user operates the terminal to select classification information, view inquiry information, and supply response information. The user does not directly interact with the database, the tabular data-processing layer, or the generative AI model. The user instead manipulates graphical user interface components rendered on the terminal's display screen. The user may select one classification information item, such as a service category, by activating a control element. The user may then enter numeric values, free text, option selections, or voice input in response to inquiry information presented by the terminal.

The server generates guidance information to enable the user to select classification information. The server stores multiple classification information items in a structured data structure, such as a table in the database or a table in a tabular data-processing library. The server associates each classification information item with a unique identifier, a display label, and linkage metadata to related inquiry information. By organizing classification information in a column-oriented structure, the server can retrieve and update classification information using index-based access, thereby reducing the number of random memory accesses compared to a purely object-based representation. This structural design improves memory locality and cache utilization during classification information retrieval.

The server associates inquiry information with each classification information item. For each classification information item, the server defines a set of inquiry information items in a data table including columns for an inquiry identifier, a classification identifier, an inquiry text, an expected data type, an input widget type, and an internal field name for response binding. The server may further store validation constraints, such as minimum and maximum values or enumerated choices, within the same tabular structure. By consolidating inquiry information into a table, the server is able to apply vectorized operations for updates, filtering, and language switching, which reduces processing time when multiple inquiry information items are managed.

The server stores service information groups in another data table. Each row of the table corresponds to one service information item, and each column represents an attribute such as category, basic fee, optional fee, data capacity, contract duration, feature flags, and derived metrics. The server chooses column names and data types so that mathematical operations, filtering conditions, and joins can be executed directly through the tabular data-processing library. This table-based storage allows the server to perform vectorized comparisons, aggregations, and sorts, which improve computational throughput and reduce instruction overhead compared to manually iterating over arrays or collections in application logic.

The server uses a template engine to generate guidance information and inquiry information as structured documents. The server defines template documents that contain placeholders for classification information and inquiry information. The server passes the tabular data of classification and inquiry information to the template engine, which performs substitution of placeholders with actual text for the current language type and context. Because template processing and data processing are separated, the server may update the user interface appearance without modifying the logic that computes condition information and fee information. This separation reduces coupling between user interface code and processing code, thereby improving maintainability and reducing error propagation when either side changes.

The server uses a generative AI model to generate explanation information corresponding to candidate service information. In one embodiment, the server accesses a generative AI model implemented as a neural network having an encoder-decoder architecture with an attention mechanism. The model contains multiple layers of self-attention blocks, feed-forward networks, and normalization layers. The model is pretrained on large-scale text corpora to learn linguistic patterns and is further fine-tuned on domain-specific explanation data. The model is parameterized by weight matrices and bias vectors that are updated during a training phase using a stochastic gradient descent algorithm or a variant such as Adam. During training, the server or a training system minimizes a loss function such as cross-entropy between predicted tokens and ground-truth tokens. The training system computes gradients by backpropagation and updates the weights. This training process leads to a parameter configuration that captures relevant relationships between input prompt sentences and output explanation information.

The server does not treat the generative AI model as a black box that replaces human authors. The server instead uses structured prompt sentences designed to exploit the model's architecture and learned representations. The server constructs each prompt sentence by concatenating machine-readable descriptions of classification information, normalized response information, and candidate service information in a predetermined format. For example, the server can construct a prompt sentence such as:
“The user selected the category: Communication. The user's monthly budget is: 5000 yen. The user's minimum required data capacity is: 10 GB. The candidate service plan is: Plan A, 20 GB, 4800 yen per month, 24-month contract, includes tethering. Explain in concise natural language why this candidate service plan is suitable for the user.”

Because the prompt sentence encodes structured attributes in a consistent order, the generative AI model can leverage its attention mechanism to align tokens corresponding to the budget, capacity, and price. This alignment reduces ambiguity, which improves the stability and predictability of the generated explanation information. The effect is a systematic improvement in explanation quality, leading to fewer user clarification requests and reduced total network traffic between the server and the generative AI model API due to fewer retries.

The server integrates multilingual support within the same processing pipeline. The server stores language types and mapping tables between abstract message identifiers and language-specific character information in a table. When the server generates guidance information, inquiry information, and explanation information, the server selects the appropriate language type based on a setting associated with the user or the terminal. For static text such as classification labels and inquiry texts, the server directly maps abstract identifiers to character information in the selected language. For dynamic text generated by the generative AI model, the server includes language instructions in the prompt sentence, such as:
“Write the explanation in Japanese using polite but concise style.”

By embedding explicit language instructions, the server ensures that the generative AI model outputs explanation information in the requested language type. The server thereby avoids separate translation processing, which reduces processing time and memory usage.

The server also integrates voice input into the response information acquisition process. The terminal uses a voice acquisition apparatus, such as a microphone, to capture analog audio signals corresponding to the user's speech. The terminal digitizes the audio signals with an analog-to-digital converter and encodes them as a digital audio stream. The server receives the audio stream or a compressed representation and applies voice analysis software, such as an automatic speech recognition engine. The voice analysis software transforms sequential acoustic feature vectors into token sequences representing characters or words. The software may use a neural network acoustic model, such as a recurrent neural network or a transformer-based model, and a language model to produce the most likely text sequence for the speech input. The server converts the recognized text into response information by mapping words and numbers to normalized values stored in a table. This process allows users to provide response information without typing, while the server maintains a consistent internal representation for subsequent tabular processing and generative AI prompt construction.

The server improves processing speed and resource usage in comparison to a naive implementation that performs recommendation logic purely in application code. Because the server uses the tabular data-processing library to apply vectorized operations to service information groups, the server performs condition evaluation, range filtering, and metric computation using optimized loops and low-level optimizations provided by the library. For example, when the server computes two-year total costs for thousands of service information items, the server instructs the tabular data-processing library to multiply the monthly fee column by the contract duration column for all records in a single operation. This operation is executed in compiled code using optimized memory access patterns, which significantly reduces CPU cycles per record relative to iterating in an interpreter and performing scalar multiplications. The resulting performance improvement enables the server to handle more concurrent user sessions without requiring linear scaling of hardware resources.

The server improves accuracy and consistency of candidate service information selection. The server defines explicit filtering conditions and scoring functions on columns in the service information groups. For example, the server can store a scoring formula such as:

$$score = w 1 \times normalized\_monthly \_fee + w 2 \times normalized\_data \_capacity + w 3 \times normalized\_contract \_flexibility$$

in a separate configuration table. The server applies this scoring function by computing normalized values and weighted sums for each service information item. Because the scoring calculation is executed using the tabular data-processing library, the server guarantees that the same formula is applied uniformly across all records. This reduces human error and inconsistency that might occur if developers manually re-implement filtering and scoring logic in separate modules.

The server includes an internal module architecture that separates user interaction, data management, recommendation computation, generative AI interaction, and document generation. One module manages communication with the terminal and the rendering of guidance information and inquiry information. Another module manages tabular storage of classification information, inquiry information, and service information groups. A recommendation engine module receives normalized response information, operates on the tabular data to select candidate service information, and outputs structured candidate service data. A generative AI interaction module constructs prompt sentences, invokes the generative AI model, and returns explanation information. A document generation module merges structured candidate service data and explanation information into structured documents for display on the terminal. This modular architecture allows each module to be optimized and scaled independently. For example, the recommendation engine can run in a process pool to parallelize table operations, while the generative AI interaction module can buffer and batch requests to the generative AI model, thereby reducing network overhead and latency.

The use of the generative AI model in this system is not a simple replacement for a human operator writing explanations. The server takes advantage of the model's ability to process long prompt sentences and to attend to multiple features in structured input. The server encodes internal identifiers, numeric values, and feature flags into prompt sentences in a particular order and with explicit labels. These prompt design rules represent a non-conventional approach compared to typical chat-style prompts. As a result, the generative AI model can more reliably reference specific attributes, such as contract length, fee thresholds, or data capacity, when generating explanation information. This reduces hallucinations and irrelevant explanations, improving the technical reliability of the overall recommendation function.

The server can use different generative AI model configurations in alternative embodiments. In one embodiment, the server uses an external generative AI model service accessible via a network, and transmits prompt sentences as text strings in a request message to the external service. In another embodiment, the server hosts the generative AI model locally, loading model parameters from a storage device into memory and performing forward propagation on a graphics processing unit or a specialized accelerator. In a further embodiment, the server uses a smaller generative AI model for low-latency operation on resource-limited hardware, while a more complex model is used for high-value users or batch explanation generation. In each case, the server maintains the same structured prompt sentence format and uses the same internal data flow, which simplifies integration and testing.

The server provides technical benefits beyond mere automation of human tasks. The server reduces communication load between the server and the terminal by aggregating multiple user inputs into a single response information structure and returning candidate service information and explanation information in a single structured document rather than in multiple incremental responses. The server reduces memory usage by storing service information groups and inquiry information in normalized tables and by avoiding duplication of text for each user session. The server improves latency by using vectorized tabular processing rather than iterative processing, and by issuing generative AI model calls only after candidate service information has been narrowed to a small subset of records. The server also improves robustness, because the explicit separation between deterministic tabular processing and generative explanation processing ensures that errors in explanation generation do not affect the underlying candidate selection logic.

The terminal can also be realized in alternative forms. In one embodiment, the terminal includes additional local processing functions, such as client-side validation of response information and local caching of static template fragments. In another embodiment, the terminal uses a native application that communicates with the server through a programmatic interface and renders information using native user interface components instead of a web browser. In a further embodiment, the terminal integrates a local speech recognition engine for initial conversion of voice input to text, and the server receives already-recognized text as response information. In all such configurations, the server retains control over the tabular processing, candidate service information selection, generative AI prompt construction, and structured document generation. The user may interact with the system in various use scenarios. For example, the user may seek an optimal communication service plan. The server presents classification information for different service categories, such as communications, energy supply, or insurance. The user selects the communications category on the terminal display. The server retrieves the associated inquiry information, such as questions about monthly budget, required data capacity, contract flexibility, and roaming needs, and sends this inquiry information to the terminal as part of a structured document. The user inputs a monthly budget of 5000 currency units and a minimum data capacity of 10 units, then submits the responses. The server converts the raw inputs into normalized response information, filters the service information groups to items in the communications category, applies tabular operations to compute metrics such as total cost and cost per unit of capacity, and selects a candidate service information item whose fee and capacity satisfy the constraints. The server constructs a prompt sentence containing the classification information, the normalized response information, and the selected candidate service information, sends the prompt sentence to the generative AI model, receives explanation information describing why the selected plan is suitable, and then generates a structured document combining the numerical details and the explanation information. The terminal displays the structured document, and the user can make a more informed decision based on both structured data and narrative explanation.

In another scenario, the user prefers to use voice rather than text input. The server sends the same inquiry information to the terminal. The user responds verbally, indicating a budget and required capacity. The terminal captures the speech signal and sends it to the server. The server's voice analysis software transforms the speech into characters and then into normalized numerical values. The rest of the data flow remains unchanged, and the server processes the normalized response information using the tabular data-processing library and the generative AI model. This uniform treatment of text-based and voice-based input simplifies the implementation of downstream modules and reduces the risk of errors arising from maintaining separate code paths for different input modes.

Through these configurations, the server, the terminal, and the user cooperate within an integrated system that improves the way that a computer processes classification information, inquiry information, response information, service information groups, and explanation information. The system uses specific data structures, algorithms, and model architectures to achieve technical effects such as improved processing speed, better scalability, reduced memory usage, more accurate and consistent candidate selection, reduced communication load, and more reliable generative explanations.

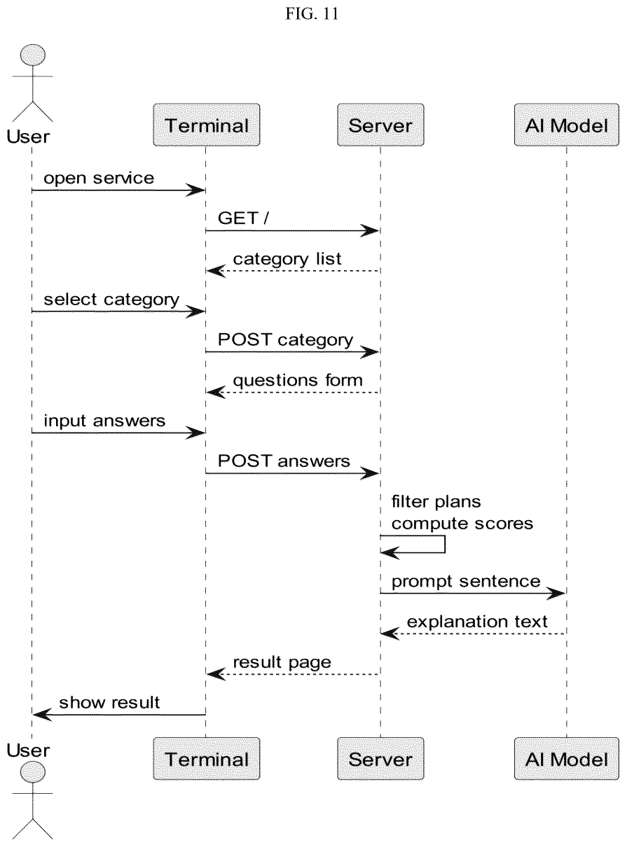

The following describes the processing flow using FIG. 11.

### Step 1:

The server prepares master data and initializes modules.

The server loads classification information, inquiry information, and service information groups from a storage device into memory-resident data structures of a tabular data-processing library. As input, the server receives raw records from a database or structured files and converts them into tables where each column represents an attribute (for example, category identifier, question text, monthly fee, data capacity). The server also loads template definitions for guidance screens and result screens into a template engine and sets connection parameters for a generative AI model endpoint. As output, the server maintains initialized in-memory tables and template objects that can be accessed efficiently during subsequent processing.

### Step 2:

The terminal requests and displays classification information.

The terminal sends an initial access request to the server. As input, the terminal receives a structured document from the server that includes a list of classification information items, each with an identifier and a display label. The terminal parses the structured document, constructs a user interface with selectable elements (for example, buttons or list items) for each classification information item, and renders them on the display unit. As output, the terminal presents a screen that allows the user to choose one classification information item.

### Step 3:

The user selects classification information.

The user observes the classification information displayed on the terminal and selects a desired category by activating a corresponding user interface element (for example, tapping “Communication”). As input, the user uses a touch operation, mouse click, or keyboard action on the displayed classification information. The terminal converts this selection into selection information containing a classification identifier and sends it to the server. As output, the user generates a specific classification choice that will drive the selection of inquiry information.

### Step 4:

The server retrieves inquiry information for the selected classification.

The server receives the selection information including the classification identifier from the terminal. As input, the server obtains the classification identifier and looks up rows in the inquiry information table where a classification column matches the received identifier. The server applies a filter operation in the tabular data-processing library to extract only inquiry information items that are associated with the selected classification. As output, the server generates a subset table containing the relevant inquiry information items, including their texts, expected data types, and internal field names.

### Step 5:

The server generates and sends an inquiry screen.

The server uses the template engine to incorporate the subset table of inquiry information into a structured document representing an inquiry screen. As input, the server provides the template with the inquiry texts, field names, and any validation constraints retrieved from the table. The template engine replaces placeholders in the template with these values and constructs form elements (for example, text fields, dropdowns, radio buttons) linked to the internal field names. As output, the server transmits the generated structured document to the terminal, which includes all inquiry information to be presented to the user.

### Step 6:

The terminal displays inquiry information and accepts responses.

The terminal receives the structured document containing the inquiry information from the server. As input, the terminal parses the document, builds a layout with labeled input elements, and renders the inquiry texts and input fields on the display unit. The user then enters response information by typing values, selecting options, or providing voice input through the terminal. The terminal may perform basic checks (for example, mandatory field checks or numeric range checks) using local logic. As output, the terminal collects the user's responses in association with the internal field names and prepares them for transmission to the server.

### Step 7:

The terminal sends response information to the server.

The terminal packages the response information into a request message. As input, the terminal uses the values entered or spoken by the user in each input element, associates them with their respective internal field names, and formats them as structured key-value pairs. The terminal sends this message over the network to the server. As output, the terminal provides the server with a structured set of response information representing the user's answers to the inquiry information.

### Step 8:

The server normalizes and validates response information.

The server receives the structured response information from the terminal. As input, the server obtains key-value pairs where each key corresponds to an internal field name and each value is a raw string or recognized text. The server converts these strings into normalized data types (for example, integers for budget, floating-point numbers for data capacity, Boolean values for feature flags) and applies validation rules defined in the inquiry information table (for example, verifying that budget is non-negative and within a predefined maximum). As output, the server produces a normalized response record that is consistent with the data types and constraints required for further tabular processing.

### Step 9:

The server filters service information groups based on normalized response information.

The server uses the normalized response record to filter the service information groups table. As input, the server takes the normalized values, such as a selected classification identifier, budget, minimum data capacity, and required features. The server constructs filter conditions on columns of the service information groups table (for example, category equals selected classification, monthly fee less than or equal to budget, data capacity greater than or equal to required capacity, feature flags matching required options). The tabular data-processing library applies these conditions in vectorized form across all rows. As output, the server obtains a filtered table containing only service information items that satisfy all constraints implied by the response information.

### Step 10:

The server computes evaluation metrics and selects candidate service information.

The server calculates evaluation metrics for each row in the filtered table. As input, the server uses columns such as monthly fee, contract duration, and data capacity from the filtered table. The server performs arithmetic operations (for example, multiplying monthly fee by contract duration to compute total cost, dividing monthly fee by data capacity to compute cost per unit, and combining normalized values with predetermined weights to compute a score). The tabular data-processing library carries out these operations column-wise. As output, the server adds metric columns to the filtered table and sorts the table using the score or another metric, then selects one or more top-ranked rows as candidate service information items.

### Step 11:

The server constructs a prompt sentence for the generative AI model.

The server prepares textual input to the generative AI model using the normalized response record and the selected candidate service information. As input, the server retrieves the classification information (for example, category name), the user's normalized responses (for example, budget and required data capacity), and attributes of the selected candidate service information (for example, plan name, monthly fee, contract duration, additional features). The server concatenates these elements into a formatted prompt sentence, including labels for each attribute, such as:
“The user selected the category: Communication. The user's monthly budget is: 5000 yen. The user's minimum required data capacity is: 10 GB. The candidate service plan is: Plan A, 20 GB, 4800 yen per month, 24-month contract, includes tethering. Explain in concise natural language why this candidate service plan is suitable for the user.”

As output, the server generates a prompt sentence string ready to be sent to the generative AI model.

### Step 12:

The server sends the prompt sentence to the generative AI model and receives explanation information.

The server transmits the prompt sentence to the generative AI model via a communication interface or an application programming interface. As input, the server uses the text prompt sentence and associated parameters (for example, maximum output length or temperature setting). The generative AI model internally performs tokenization, embedding, and layer-by-layer neural computation to produce a sequence of output tokens that form explanation information. The server receives the generated explanation information from the generative AI model as a text string. As output, the server stores the explanation information and associates it with the corresponding candidate service information.

### Step 13:

The server constructs result information combining candidate service information and explanation information.

The server merges structured numeric and categorical attributes of the candidate service information with the explanation information produced by the generative AI model. As input, the server takes the candidate service table rows, including computed metrics, and the explanation text. The server creates a result data structure that includes fields for plan identifiers, fees, condition information, and the corresponding explanatory paragraphs. The server may also insert display formatting hints or ranking labels in this result structure. As output, the server provides a consolidated result information object representing the final recommendation content.

### Step 14:

The server generates a structured document for presentation of results.

The server uses the template engine to render the result information into a structured document suitable for display on the terminal. As input, the server passes the result information object and a result template to the template engine. The template engine iterates over the candidate service items, inserts numeric fields into appropriate positions (for example, in table cells or labeled sections), and places the explanation text next to or below each candidate service description. As output, the server obtains a complete structured document, such as a markup-based page, containing both tabular data and narrative explanation.

### Step 15:

The terminal receives and displays the structured document containing results.

The terminal receives the structured document from the server as input. The terminal parses the document, arranges text blocks, tables, and headings on the display unit, and renders the candidate service information and the associated explanation information. The user can then view detailed fees, conditions, and justifications for each candidate service item. As output, the terminal presents a human-readable result screen that reflects the computations and generative explanation carried out by the server, enabling the user to understand the recommendation and decide whether to accept or adjust preferences.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation and contracting systems generally rely on static questionnaires or manually curated decision trees. In such systems, a fixed set of questions is predefined by human designers and stored in a database or application code. As a result, when a user selects a particular category of products or services, the system repeatedly presents the same or similar questions, regardless of changes in user behavior, product offerings, or business rules. This rigid design limits the system's ability to accurately capture diverse and evolving user preferences and conditions, and therefore reduces the precision and relevance of the recommended items or services.

Moreover, in many existing architectures, the server merely displays static forms, collects field-level input, and applies simple rule-based filtering on a product or service database. The server typically lacks a flexible mechanism to dynamically construct queries or ranking criteria based on rich, semantically meaningful user responses. This can lead to suboptimal use of computing resources, redundant network traffic due to multiple back-and-forth interactions for clarification, and an overall increase in latency before a user receives useful proposals. From a computer-technology standpoint, the absence of an integrated flow that tightly couples dynamic question generation, structured parameter extraction, database search, ranking, and contract processing results in inefficient data processing and underutilization of the underlying computing platform.

Additionally, when systems attempt to support multiple languages and modalities (for example, text and voice), conventional implementations often treat language handling and voice input/output as add-on layers that are loosely integrated with the core recommendation and contracting logic. This fragmentation typically requires separate configuration, duplicated logic, or parallel data paths. Such fragmentation increases processing complexity and memory footprint on the server, degrades maintainability, and makes it difficult to guarantee consistent behavior across languages and input modalities. The result is an increased burden on the computing infrastructure and a higher risk of inconsistent or erroneous processing.

Further, traditional identity verification workflows are frequently implemented as separate modules or external processes triggered after proposal generation. These modules may not be deeply integrated into the server's main control flow and may rely on ad hoc interfaces to associate verification results with contract records. This can cause synchronization issues between recommendation results and contract registration, require additional database lookups, and introduce race conditions or failure points in distributed environments. Consequently, the overall computing system may experience increased processing overhead, longer end-to-end transaction times, and a higher probability of incomplete or inconsistent contract records.

Accordingly, there is a need for an improved computer-implemented system and server-side control flow that: (i) uses a generative AI model in a tightly integrated manner to dynamically generate category-specific questions from prompt sentences; (ii) normalizes and converts user responses into structured attribute information suitable for efficient database searching and ranking; (iii) coordinates, within a unified processor-controlled pipeline, question generation, answer analysis, database retrieval, ranking, presentation of conditions and fees, and identity-based contract registration; and (iv) handles multilingual prompt sentences and voice-based input/output in a coherent, centrally managed architecture. Such an improvement in the server's internal processing architecture constitutes an advancement in computer technology by improving the way computing resources are orchestrated to collect, transform, and apply user data to generate and finalize tailored product or service contracts.

The specific processing by the specific processing unit 290 of the data processing device 12 in Application Example 1 is realized by the following means.

The present invention provides a server comprising a processor configured to receive, via an information processing apparatus, selection information indicating a classification item selected by a user; generate, based on the classification item, a prompt sentence for a generative information processing model; cause the generative information processing model to generate, using the prompt sentence, a plurality of question sentences related to the classification item; provide the plurality of question sentences to the user via the information processing apparatus; acquire, via the information processing apparatus, response information corresponding to the plurality of question sentences; normalize the response information and convert the normalized response information into attribute information representing preferences or conditions of the user; search, based on the attribute information, item information or service information stored in a storage device; calculate a degree of matching between the attribute information and each piece of the item information or the service information; extract the item information or the service information according to a ranking based on the degree of matching; calculate or format condition information and fee information included in the extracted item information or the extracted service information; provide the condition information and the fee information to a display apparatus via the information processing apparatus; execute an identification process for the user on the basis of authentication information obtained from an identification medium; and register contract information relating to the extracted item information or the extracted service information in a recording device. This enables the server to implement, in a unified and technically integrated processing pipeline, dynamic category-dependent question generation by a generative AI model, structured transformation of user responses into searchable attribute information, efficient database searching and ranking based on computed matching degrees, coherent multilingual and modality-agnostic user interaction, and tightly coupled identity verification and contract registration, thereby improving the overall efficiency, responsiveness, and reliability of the computer-based recommendation and contracting system.

The term “system” refers to an arrangement including at least one hardware device and at least one software component that cooperatively execute processing defined in the claims.

The term “processor” refers to a hardware circuit, such as a central processing unit or a processing core, that executes instructions to perform functions described in the claims.

The term “information processing apparatus” refers to a terminal device, such as a computing device including a display function and an input function, through which a user interacts with the system.

The term “user” refers to a human operator that provides input to and receives output from the system through the information processing apparatus.

The term “classification item” refers to category information indicating a type or class of products or services for which the user desires a recommendation or contract.

The term “selection information” refers to data indicating a classification item chosen by the user via the information processing apparatus.

The term “prompt sentence” refers to text data supplied as an instruction or query to a generative information processing model in order to control generation of question sentences.

The term “generative information processing model” refers to a software-based information processing model, such as a generative AI model, that generates text output, including question sentences, based on input data including a prompt sentence.

The term “question sentence” refers to a natural language text string generated by the generative information processing model and presented to the user to obtain response information.

The term “plurality of question sentences” refers to two or more question sentences that are generated and presented to the user in association with a classification item.

The term “response information” refers to data representing the user's answers to the plurality of question sentences provided via the information processing apparatus.

The term “normalize” refers to processing that converts response information into a standardized representation, including format conversion, unit conversion, or mapping to predefined categories.

The term “attribute information” refers to structured data obtained by normalizing response information, representing at least one preference, condition, or characteristic associated with the user.

The term “storage device” refers to a non-transitory computer-readable medium, such as a memory device or a storage unit, that stores item information or service information.

The term “item information” refers to data representing products, including attributes such as price, conditions, and descriptive information, which can be proposed to the user.

The term “service information” refers to data representing services, including attributes such as fees, terms, and descriptive information, which can be proposed to the user.

The term “degree of matching” refers to a value computed by the processor that quantitatively represents how well attribute information corresponds to item information or service information.

The term “ranking” refers to an ordered arrangement of item information or service information based on respective degrees of matching.

The term “condition information” refers to data representing terms, requirements, or constraints associated with item information or service information, including contract conditions.

The term “fee information” refers to data representing monetary amounts, prices, or charges associated with item information or service information.

The term “display apparatus” refers to a device or component capable of visually presenting information to the user, such as a display of the information processing apparatus.

The term “identification medium” refers to a physical or electronic medium, such as an identification card or equivalent credential, from which authentication information related to the user can be obtained.

The term “authentication information” refers to data extracted from the identification medium, including information used to verify the identity of the user.

The term “identification process” refers to processing by which the processor verifies the identity of the user based on authentication information.

The term “recording device” refers to a non-transitory computer-readable medium or storage unit that records contract information in association with item information or service information.

The term “contract information” refers to data representing a contractual relationship established between the user and a provider of item information or service information, including identifiers, conditions, and fee-related data.

The term “language type” refers to a particular natural language, such as a specific linguistic system, used for generating the prompt sentence or the question sentences.

The term “voice input/output apparatus” refers to a device or component configured to capture voice from the user and/or output voice to the user, such as a microphone and speaker.

The term “voice information” refers to audio data representing spoken utterances by the user or audio output presented to the user.

The term “character information” refers to textual data obtained by converting voice information or used for presenting textual content to the user.

The term “voice recognition processing” refers to processing that converts voice information into character information using a speech recognition technique.

In one embodiment, a server executes a recommendation and contracting system that utilizes a generative AI model and prompt sentences to dynamically generate category-dependent questions, structure user responses, and register contracts based on identification media. A terminal operates as an information processing apparatus through which a user interacts with the server. The server includes at least one processor, a main memory, and one or more storage devices such as a relational database, all interconnected via a communication bus. The server is connected to the terminal over a communication network, such as the Internet, using secure communication protocols.

The server executes an application program implemented, for example, using a server-side framework such as a general web framework, and communicates with a generative AI model that is deployed either as a cloud-based service or as an on-premise inference engine. The generative AI model is implemented as a neural network, for example a transformer-based language model, that processes prompt sentences and generates question sentences in natural language. The server stores item information and service information in a database management system such as a relational database, and the server maintains contract information and user identification information in structured tables.

The terminal includes a display apparatus, an input apparatus, and optionally a voice input/output apparatus. The terminal executes a client application, such as a web browser or a native application, that displays user interfaces transmitted from the server and captures user input including category selection, answers to questions, and identity information. The user operates the terminal to select classification items, respond to generated questions, and provide identification media such as an identification card.

The server uses a specific internal data structure to represent classification items, prompt sentences, question sentences, response information, attribute information, item information, service information, and contract information. For example, the server represents each classification item as an identifier and a set of metadata indicating domain type, supported attributes, and expected question dimensions. The server represents a prompt sentence as a text string combined with a parameter structure indicating language type, desired number of questions, and question constraints. The server represents each question sentence as a record containing a question identifier, a text field, a question type field, and optional option lists for multiple-choice questions. The server represents response information as pairs of question identifiers and raw answer values. The server then transforms response information into attribute information, which is stored as structured fields such as numeric ranges, enumerated types, and Boolean flags.

The server uses the generative AI model in a non-generic manner to improve internal data processing. The server does not merely replace human-written questions but integrates the output of the generative AI model with a structured attribute extraction pipeline and a specific ranking algorithm that reduces redundant interactions and computational overhead. The server configures the generative AI model as a transformer-based neural network that includes multiple self-attention layers, feed-forward layers, and layer normalization components. The generative AI model is trained using a corpus of domain-agnostic text and optionally fine-tuned using domain-specific dialog pairs and question examples. During training, the generative AI model minimizes a cross-entropy loss between predicted tokens and ground truth tokens, updates weights using gradient-based optimization such as stochastic gradient descent or an adaptive optimizer, and uses regularization methods such as dropout and weight decay.

The server controls the generative AI model at inference time by constructing specific prompt sentences that encode the selected classification item and constraints on question type and content. In one example, when the user selects a classification item corresponding to fashion-related products, the server composes a prompt sentence such as:
“Category: Fashion. Please generate 7 concise questions that will help understand the user's budget, preferred style, preferred colors, size, and usage scenes (daily, business, party, outdoor). The goal is to recommend optimal products from a product database. Output only the questions as a numbered list.”

In another example, when the user selects a classification item corresponding to travel insurance services, the server composes a prompt sentence such as:
“Category: Travel Insurance. Please generate a set of questions needed to recommend suitable insurance plans. Ask about travel destination, trip duration, traveler's age, travel purpose, planned activities including any high-risk activities, and desired coverage level. Output the questions as a numbered list, each question in one sentence.”

The server selects a language type for each prompt sentence based on user preferences or terminal settings. By changing the language type parameter fed into the prompt construction logic, the server causes the generative AI model to produce question sentences in different natural languages without duplicating business logic or maintaining separate static text repositories. This reduces memory consumption and configuration complexity compared to conventional multi-language support solutions.

The server receives the question sentences generated by the generative AI model and transforms them into structured internal objects. The server performs parsing of the generated text, for example by detecting numbered list markers or line breaks, assigns question identifiers, and classifies question types by applying rule-based pattern matching to the generated sentences. In one embodiment, the server uses a predefined rule set that maps lexical patterns, such as “How much” or “What is your budget,” to a numeric-range question type, and patterns such as “Which of the following styles” to a multiple-choice question type. This internal classification enables the server to associate each question sentence with expected answer formats, thereby reducing later parsing ambiguity and improving computational efficiency.

The server sends the structured question objects to the terminal. The terminal renders the questions using corresponding user interface elements: numeric input fields for budget questions, dropdown lists for style categories, or text input areas for free-text responses. The user enters answers, and the terminal transmits response information to the server in accordance with the assigned question identifiers. When a voice input/output apparatus is available, the terminal captures voice information and sends it to the server or a voice-recognition module. The server converts voice information into character information using a voice recognition processing component such as a speech recognition engine based on acoustic and language models. This conversion is integrated into the same attribute extraction pipeline used for text-based inputs.

The server normalizes response information into attribute information using non-trivial computational rules. For numeric values such as budgets or durations, the server converts text representations into normalized numeric units, adjusts for currency or unit differences, and stores values as numerical ranges. For categorical preferences such as “casual style,” “business style,” or “formal style,” the server maps free-text or multi-language expressions to standardized tags by applying tokenization, lowercasing, and dictionary-based mappings, combined with similarity thresholds computed by vector embeddings. When the server uses vector embeddings, the server computes vector representations of response phrases and compares them against pre-computed vectors representing canonical categories. The server calculates similarity scores, for example cosine similarity, and assigns category tags when the similarity exceeds a predetermined threshold.

The server uses attribute information to perform efficient database searches. The server maintains item information and service information in tables that include indexed fields corresponding to price, category, style, coverage, and other attributes. By converting user responses into normalized, indexed-compatible fields, the server reduces complex string searching and instead uses index-based retrieval operations that are more efficient and scalable. The server executes queries that take advantage of composite indexes on frequently combined attributes, which reduces input/output operations on the storage device and lowers query latency.

The server performs ranking using a scoring function that combines multiple attributes. For each candidate item or service obtained from the database, the server computes a degree of matching as a weighted sum or more advanced function of individual attribute match scores. For example, the server calculates a budget match score based on how close the item price is to the user's specified maximum budget, a style match score based on matching style tags, and an availability score based on stock or capacity. The server then combines these scores with configurable weights, which are stored in configuration data. In an alternative embodiment, the server applies a machine-learning-based ranking model, such as a gradient boosting model or a neural network trained to predict user satisfaction or selection likelihood, using the attribute information and item attributes as feature vectors.

By integrating dynamic question generation, structured normalization, and ranking, the server reduces the number of interaction rounds needed to obtain sufficient information for high-quality proposals. This results in fewer network round trips between the terminal and the server and less repeated transmission of redundant data. As a consequence, the system reduces communication load and improves end-to-end response time, which constitutes a technical improvement in networked computer operation.

The server further integrates identification processing and contract registration into the same computational pipeline. The terminal acquires authentication information from an identification medium such as an identification card using a camera or card reader. The terminal optionally uses an optical character recognition module or another reading component to extract textual data such as name, date of birth, and identification number. The terminal sends this authentication information to the server. The server verifies consistency, format, and validity of the information, possibly using external verification services. The server then binds the verified user identity with contract information stored in the recording device, ensuring that contract records are consistently and reliably linked to identity information.

This integrated approach avoids separate and loosely coupled modules for recommendation and identity verification, which can introduce synchronization delays and inconsistencies in conventional systems. By centralizing control in the processor of the server and by using shared data structures for attribute information, item information, service information, and contract information, the system achieves more efficient memory management and reduced duplication of data across modules.

The server improves computer technology by restructuring the internal flow of data and control signals. Instead of using a static questionnaire engine and a simple rule-based filter, the server uses a generative AI model to produce flexible, context-dependent questions, while constraining that model through structured prompt sentences and a normalization pipeline. This combination enables the server to generate only those questions that are necessary to disambiguate user preferences relative to the current inventory of items and services, thus reducing unnecessary processing. The server retains control over the generative AI model via systematic prompt construction, parameter setting, and post-generation parsing, rather than relying on uncontrolled natural language outputs.

The server configures the generative AI model with specific parameters, such as maximum output length, temperature, and top-k or top-p sampling parameters, to balance variety and determinism in question generation. The server may store different parameter sets for different classification items or different usage contexts, thereby customizing model behavior in a reproducible and controlled manner. This configuration, together with prompt design, constitutes a specific technical solution for using a generative AI model as a component of a structured data processing pipeline.

The server uses learned weights of the generative AI model and its ability to infer context across tokens to compress and encode complex question logic in a model representation, rather than in large, manually maintained decision trees. This reduces the amount of explicit rule data that needs to be stored and processed by rule engines, decreasing memory usage and rule evaluation overhead. The server then re-expands this compact representation into natural language questions on demand, guided by prompt sentences. This approach provides a technical effect similar to model-based compression and decompression of question logic, distinct from simple automation of human-written scripts.

The server further enhances the technical effect by supporting multi-language operation without replicating rule sets. The server constructs prompt sentences in different language types, but maps the resulting question sentences and responses into the same internal attribute representation. By centralizing normalization and attribute mapping in a language-agnostic layer, the server reduces code duplication and data structure redundancy that would otherwise be necessary for each additional language. This improves maintainability and reduces the likelihood of inconsistent logic across localized components.

In addition, the server supports voice-based interactions by converting voice information into character information and feeding the resulting text into the same normalization pipeline. The server thereby unifies processing for text and voice inputs. This unification leads to reduced complexity in input handling modules and avoids separate parallel systems for each modality. The server can reuse ranking and contract registration logic regardless of whether input was provided as text or voice, leading to simplified system architecture and reduced computational overhead.

In one alternative embodiment, the server deploys the generative AI model on a separate hardware accelerator, such as a graphics processing unit or a dedicated inference processor, while maintaining the normalization, search, and ranking logic on a general-purpose central processing unit. The server orchestrates data transfer between these processors in a batched manner, so that multiple prompt sentences or question generation tasks share the same model invocation. This batched processing reduces context switching overhead and improves throughput for concurrent users. The server thus achieves a technical improvement in resource utilization by adapting the internal scheduling of AI inference tasks to the dynamic workload.

In another alternative embodiment, the server stores historical attribute information and ranking results to refine subsequent question generation. For example, the server aggregates statistics on which questions yield the greatest reduction in ambiguity for given classification items and uses these statistics to adjust future prompt sentences. The server may encode such aggregation into prompt instructions, emphasizing particular question dimensions that historically improved matching accuracy. This feedback loop allows the system to self-optimize its interaction pattern without modifying core application code, thereby enhancing adaptability and long-term efficiency.

In all embodiments, the server uses structured data representations, specific neural network architectures and training methods, controlled prompt-based text generation, and a defined normalization and ranking pipeline that together lead to measurable improvements in processing speed, matching accuracy, communication efficiency, and reliability of contract registration. The user, the terminal, and the server cooperate within this architecture, but the key improvements reside in the way the server orchestrates generative AI, structured attribute extraction, database operations, and identification processing to enhance computer-based recommendation and contracting beyond mere automation of manual procedures.

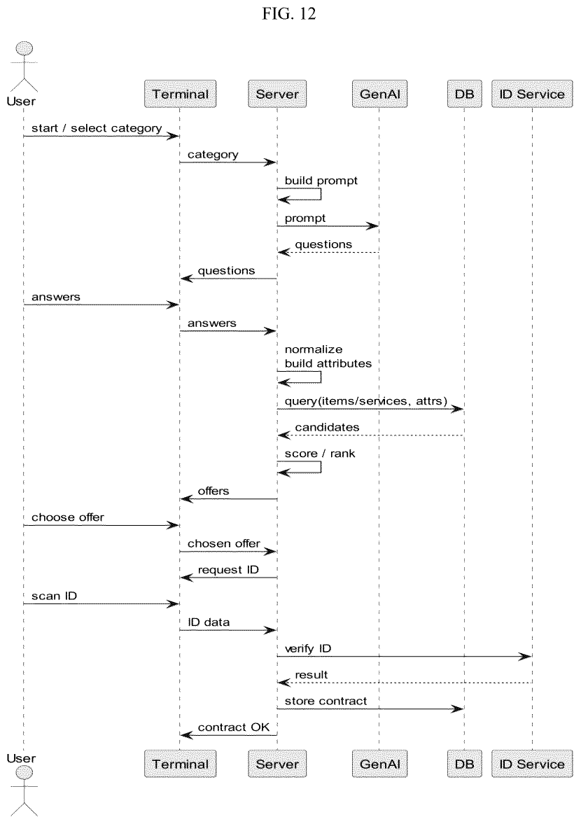

The following describes the processing flow using FIG. 12.

### Step 1:

User operates Terminal to start the service and to select a classification item.

User views, on a display of Terminal, a list of available classification items such as categories of products or services.

Input: A list of classification items rendered by Terminal, each associated with an internal identifier provided earlier by Server.

User taps or clicks one classification item.

Output: Terminal obtains selection information indicating the chosen classification item.

Terminal converts the user's selection into structured selection information, for example an internal category identifier and language preference, and prepares a request message.

Terminal sends the selection information to Server via a network request.

### Step 2:

Server receives the selection information and constructs a prompt sentence.

Input: Selection information including a classification item identifier and optionally a language type and user profile data.

Server retrieves, from a configuration storage, metadata associated with the classification item, such as expected question dimensions (budget, style, duration, coverage level).

Server performs data processing that combines the classification item metadata, the language type, and predefined instruction templates to build a prompt sentence string.

Server may, for example, concatenate static instruction phrases with dynamic placeholders filled with classification item labels and question constraints.

Output: A fully constructed prompt sentence text that encodes the category context, question requirements, language specification, and output format instructions for the generative AI model.

### Step 3:

Server calls the generative AI model to generate question sentences.

Input: The prompt sentence created in Step 2 and configuration parameters for the generative AI model (for example, maximum token length, temperature, and sampling parameters).

Server packages the prompt sentence and parameters into a request payload and transmits it to the generative AI model running on an inference engine.

The generative AI model, implemented as a trained transformer-based neural network, receives the prompt sentence, encodes it into token embeddings, propagates the embeddings through self-attention and feed-forward layers, and generates token sequences representing question sentences.

The model minimizes an internal predictive loss during training, and at inference uses the learned weights and decoding algorithm (such as greedy decoding or top-p sampling) to produce coherent question sentences.

Output: Server receives a text response containing a plurality of question sentences related to the classification item.

### Step 4:

Server parses the generated text into structured question objects and sends them to Terminal.

Input: Raw text output from the generative AI model, typically formatted as a numbered list of questions.

Server performs text processing such as splitting the response by line breaks or list markers, trimming whitespace, and filtering out empty lines.

Server assigns each parsed question a unique question identifier, infers a question type (for example, numeric, categorical, or free-text) using pattern matching and keyword detection, and associates optional option lists if predefined options are recognized.

Server constructs structured question objects including fields for identifier, text, type, and constraints.

Output: A list of structured question objects.

Server serializes the question objects into a response message and sends the message to Terminal.

### Step 5:

Terminal renders the question objects and captures response information from User.

Input: A structured list of question objects received from Server, each with text and type metadata.

Terminal generates corresponding user interface components: for numeric questions, numeric input boxes; for categorical questions, dropdown menus or radio buttons; for free-text questions, text areas.

Terminal displays all question sentences to User and associates each visible element with the corresponding question identifier.

User reads each question and enters answers using input hardware such as a touchscreen keyboard, mouse, or physical keyboard.

Terminal performs local validation, such as checking mandatory fields, verifying numeric formats, and ensuring that selection values are within defined options.

Output: Terminal collects all user input as response information, pairing each question identifier with the entered value or selected option.

Terminal bundles these pairs, together with the classification item identifier and optional language type, into a structured request and sends the response information to Server.

### Step 6:

Server normalizes response information into attribute information.

Input: Response information from Terminal, including question identifiers and raw answer values such as text strings, numbers, or selected options.

Server retrieves question definitions associated with each question identifier to determine expected data types and normalization rules.

Server, for numeric answers such as budgets or durations, parses text values into numeric variables, converts currency units or time units if needed, and clamps values to predefined ranges to prevent outliers.

Server, for categorical answers, maps raw text or option labels to standardized category codes using dictionaries and similarity metrics, optionally computing vector embeddings for free-text phrases and selecting the closest canonical label based on cosine similarity.

Server, for date or time fields, parses text into a standardized date-time representation and validates chronological consistency.

Server aggregates all normalized values into attribute information, such as user preferences, constraints, and profiles, represented as structured fields usable by database queries and ranking algorithms.

Output: A well-defined attribute information object representing the user's preferences and conditions in normalized form.

### Step 7:

Server searches item information and service information in a storage device based on the attribute information.

Input: Attribute information including, for example, maximum budget, style preference, coverage requirements, and duration.

Server translates attribute information into query conditions for a database management system, leveraging indexed fields such as price, category code, style tag, and coverage type.

Server constructs database queries using these conditions, optionally generating parameterized SQL statements or equivalent queries via an object-relational mapping library.

Server executes the queries against tables that store item information and service information and retrieves candidate records that satisfy the attribute-based conditions.

Server may apply post-retrieval filtering logic in memory, such as removing items outside availability windows or with incompatible eligibility rules.

Output: A candidate set of item information and service information records that meet the normalized attribute conditions.

### Step 8:

Server computes degrees of matching and ranks candidate items or services.

Input: Candidate items or services from the database and the attribute information derived from user responses.

Server defines a scoring function or ranking algorithm that takes as input the attribute information and each candidate's attributes, and outputs a degree of matching.

Server, in a simple embodiment, calculates a weighted sum of partial match scores, where each partial score quantifies similarity or compliance for a particular attribute, such as price, style, color, coverage, or duration.

Server, in a more advanced embodiment, applies a trained ranking model that uses attribute vectors as input and outputs a relevance score; the model may be trained using supervised learning with historical user selection data and a loss function such as pairwise ranking loss.

Server sorts the candidate items and services by their computed degrees of matching, discards low-scoring entries if needed, and selects a subset of top-ranked items or services for presentation.

Output: A ranked list of item information or service information records, each with an associated degree of matching.

### Step 9:

Server prepares condition information and fee information for display and sends them to Terminal.

Input: A ranked list of item or service records, including raw database fields such as base price, discount rules, term length, and eligibility conditions.

Server calculates effective fees by applying discount rules, taxes, or surcharges to base prices according to configuration parameters.

Server formats condition information into human-readable descriptions by combining attribute fields, such as term, coverage scope, limitations, and eligibility criteria, into template-based text segments.

Server composes a response that includes, for each selected item or service, the calculated fee information, condition descriptions, and identifiers required for later contract registration.

Output: A structured result set containing condition information and fee information for the top-ranked items or services.

Server transmits this result set to terminal.

### Step 10:

Terminal displays proposed conditions and fees, and User selects an item or service to proceed.

Input: The structured result set containing condition information and fee information for recommended items or services.

Terminal renders each item or service in a list or card-based interface, showing essential attributes such as name, summary, price, and main conditions.

User reviews the displayed options and, if desired, requests more details for a specific item or service; Terminal may display additional information already provided or retrieve further details from Server as needed.

User selects one item or service for contracting by activating an on-screen control such as a “Proceed” or “Apply” button.

Output: Terminal captures the identifier of the selected item or service and sends this identifier, together with session information, to Server as a selection command.

### Step 11:

Server initiates identification processing using authentication information from an identification medium.

Input: The identifier of the selected item or service and the current user session context.

Server determines, based on the configuration associated with the selected item or service, whether identity verification is required and what types of identification media are acceptable.

Server sends an instruction to Terminal indicating that an identification process must be carried out, specifying allowable media such as an identification card or a driver license.

Output: A request from Server causes Terminal to enter an identity capture mode.

### Step 12:

Terminal captures authentication information from an identification medium and sends it to Server.

Input: Instructions from Server to perform identity capture and the user's physical identification medium.

Terminal activates imaging hardware such as a camera or a card reading interface and guides User to present the identification medium.

User positions the medium according to on-screen guides, and Terminal captures image data or electronic data from the medium.

Terminal processes the captured data using local or remote recognition components; for example, Terminal applies optical character recognition to convert textual information on the identification medium into character information such as name, date of birth, address, and document number.

Terminal allows User to confirm or correct extracted values.

Output: Terminal assembles authentication information as structured data representing identity fields and sends this authentication information to Server.

### Step 13:

Server verifies the authentication information and registers contract information.

Input: Authentication information received from Terminal and the identifier of the selected item or service.

Server validates the authentication information by checking formats, verifying that mandatory fields are present, and confirming that dates such as document expiry dates are valid.

Server optionally cross-references the authentication information with existing records in a user database or with external identity verification services, using secure communication.

Server determines whether identity verification is successful based on consistency checks, verification results, and internal rules.

If verification is successful, Server generates contract information that links the verified user identity to the selected item or service, including contract identifiers, effective dates, conditions, and fee information.

Server writes the contract information to a recording device, ensuring persistence and atomicity of the write operation to avoid partial or inconsistent records.

Output: A confirmation result indicating success or failure of contract registration, together with contract identifiers and summary details upon success.

### Step 14:

Terminal presents contract completion status to User.

Input: The confirmation result, contract identifiers, and summary details received from Server.

Terminal displays a completion screen indicating that the contract has been successfully registered or explaining reasons for failure if verification did not succeed.

User views the contract summary, including identifiers, fees, and key conditions, and may store or print the information or request a copy via email or another channel.

Output: User obtains visible confirmation of contract establishment or receives guidance for corrective actions, completing the interaction for the current transaction.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional online contract systems generally require a user to manually enter personal information and contract parameters into static web forms rendered by a server. In such systems, the server typically performs only simple form rendering and basic validation, while offloading the bulk of data entry and verification to the human user. As a consequence, the systems suffer from several technical problems in terms of computer technology and human-computer interaction.

First, the server and associated client apparatuses incur significant overhead for repetitive input validation, form re-rendering, and error handling caused by human typing mistakes. Because the user manually types personal identification information, the probability of input errors is high, which leads to repeated client-server round trips, multiple page reloads, and redundant database writes. This increases network traffic, processing latency, and resource consumption on the server, thereby reducing overall system throughput and scalability.

Second, existing systems do not efficiently integrate image acquisition and character recognition into the contract processing pipeline at the system level. Even where optical character recognition is used, it is often implemented as a separate tool, requiring manual transfer of recognized data into contract fields. This fragmented approach prevents the server from automatically constructing and maintaining a structured contract data object from raw image data, forces users to manually reconcile image content and form fields, and results in inconsistent data states within backend storage.

Third, many systems provide only monolingual interfaces and rely on separate, ad-hoc localization layers or third-party translation tools. When a user operates in a foreign language, the system often has to reload entire pages or invoke external services to switch languages, causing additional latency and complicating session management. This leads to fragmented user-interface logic, duplicated templates, and increased complexity in the server software stack.

Fourth, voice input is typically handled outside the core contract system, for example by standalone speech recognition applications. As a result, the main server cannot natively treat voice-derived text as a first-class input source comparable to typed text. This leads to additional integration steps, ad-hoc scripting, and error-prone manual mapping of recognized speech to contract fields. The absence of a unified mechanism for treating voice input as structured contract data limits the system's ability to provide accessible, multimodal interaction and to optimize the end-to-end data path.

Fifth, conventional architectures do not maintain a coherent contract data structure that progresses from raw acquisition (scanned images, voice signals) through machine extraction (character recognition, speech recognition) to a finalized, user-approved state under centralized control of the server. Instead, the data path is often fragmented across multiple subsystems and user-side operations, which makes it difficult for the server to enforce consistent validation rules, audit trails, and transactional updates. This fragmentation degrades data integrity, complicates debugging, and increases the risk of inconsistent contract states.

Accordingly, there is a need for an improved computer-implemented contract system in which a server is configured to centrally orchestrate: (i) prompts that guide the user and an information processing apparatus to acquire image data of a personal identification medium; (ii) extraction of personal information from the image data via character-recognition processing; (iii) automatic population of a structured contract data object with the extracted information; (iv) multilingual presentation and interaction; and (v) optional integration of voice input as structured response or approval data. By tightly integrating these functions under unified control of the server, it becomes possible to reduce manual data entry, minimize redundant communication and processing, improve data consistency, and enhance the technical performance and usability of the contract system as a whole.

The specific processing by the specific processing unit 290 of the data processing device 12 in Example 2 is realized by the following means.

The present invention provides a server comprising a processor configured to generate prompts for causing a user, via an information processing apparatus, to select contract-target information representing at least one service to be contracted, to cause the user to read a personal identification medium by an image acquisition apparatus and to acquire image data associated with the personal identification medium, to cause the image data to be transmitted from the information processing apparatus and to cause a character-recognition processing unit to extract personal information from the image data, to cause extracted personal information to be automatically input into predetermined items of a contract data structure corresponding to the contract-target information selected by the user, to cause the automatically-input contract data structure to be presented on the information processing apparatus and to accept confirmation and correction by the user, and to cause the contract data structure to be finalized and a contract state to be updated in response to a final approval operation by the user, the processor being further configured, in certain embodiments, to generate user-facing display information in a plurality of languages and switch the display information based on a language setting of the information processing apparatus, and, in certain embodiments, to cause the information processing apparatus to acquire voice input of the user by an audio acquisition function, to convert the voice input into character data by a speech-recognition processing unit, and to process the converted character data as response data or approval data in the contract data structure. This enables the server to centrally orchestrate acquisition of raw identification data, automatic extraction and normalization of personal information, structured population and updating of contract data, multilingual user interaction, and multimodal (text and voice) inputs within a unified contract processing pipeline, thereby reducing manual data entry, lowering communication overhead, improving system responsiveness, and enhancing data integrity and usability in a computer-implemented contract environment.

The term “system” refers to an arrangement of one or more computing elements including at least one processor and associated hardware and software components that cooperate to execute the claimed functions.

The term “processor” refers to a hardware execution unit, such as a central processing unit or a processing core, that is capable of executing instructions to perform logical operations and control other components of the system.

The term “information processing apparatus” refers to a computing device operated by a user, such as a terminal, client device, or user equipment, that is capable of communicating with the server, displaying prompts, and transmitting and receiving data.

The term “user” refers to a human operator who interacts with the information processing apparatus to perform contract-related operations guided by the server.

The term “contract-target information” refers to data that identifies one or more services, products, or plans that are candidates for a contractual agreement between the user and a service provider.

The term “personal identification medium” refers to a physical identification carrier, such as an identification card or similar document, that contains personal information enabling identification of the user.

The term “image acquisition apparatus” refers to a hardware device, such as a scanner, camera, or imaging sensor, that captures an image of at least part of the personal identification medium and outputs corresponding image data.

The term “image data” refers to digital data representing an image captured by the image acquisition apparatus, including pixel values or encoded image information suitable for machine processing.

The term “character-recognition processing unit” refers to a software component, hardware component, or combination thereof configured to analyze image data and to recognize and output textual characters contained in the image data.

The term “personal information” refers to information that identifies or helps to identify the user, including, for example, a name, an address, a date of birth, or an identification number extracted from the personal identification medium.

The term “contract data structure” refers to a structured data representation, such as a record, object, or database entry, that stores fields corresponding to items of a contract, including at least user-related information and service-related information.

The term “predetermined items” refers to specified fields or elements within the contract data structure that are designated in advance to store particular categories of information, such as a name field or an address field.

The term “automatically input” refers to the operation of populating one or more predetermined items of the contract data structure by machine processing without requiring manual entry of the corresponding values by the user.

The term “prompt” refers to information, such as a message, instruction, or control signal, generated by the processor for presentation on the information processing apparatus to guide the user or to trigger operations of the apparatus.

The term “user-facing display information” refers to visual information presented on a display of the information processing apparatus, including text, icons, and graphical elements intended to be perceived and operated by the user.

The term “language setting” refers to a configuration parameter that specifies a natural language to be used for the user interface, including display information and prompts, on the information processing apparatus.

The term “contract state” refers to an indication of a current stage or status of the contract data structure in a lifecycle, including at least a draft state, a confirmed state, or an active state.

The term “final approval operation” refers to a user action, such as selecting a confirmation control or issuing an approval command, that indicates the user's acceptance of the contents of the contract data structure.

The term “audio acquisition function” refers to a capability of the information processing apparatus to capture sound, including the user's voice, via a microphone or equivalent audio sensor and to produce corresponding audio data.

The term “voice input” refers to audio data representing speech produced by the user and captured by the audio acquisition function of the information processing apparatus.

The term “speech-recognition processing unit” refers to a software component, hardware component, or combination thereof configured to receive voice input and to convert the voice input into character data representing recognized text.

The term “character data” refers to digital data representing textual symbols, such as letters, digits, or punctuation marks, that are generated, stored, or processed in a machine-readable form.

The term “response data” refers to character data that represents answers or selections provided by the user in response to questions or prompts related to the contract.

The term “approval data” refers to character data that represents the user's consent, confirmation, or agreement with respect to the contents of the contract data structure.

In one embodiment, a server provides a contract support system in which the server, at least one terminal, and at least one image acquisition apparatus cooperate to acquire, extract, and manage contract-related information. The server includes at least one processor, at least one memory storing program instructions and data structures, a network interface, and storage connected via a system bus. The terminal includes at least one processor, a display, an input device, an audio input device, and a communication interface. The image acquisition apparatus includes an optical sensor, a light source, and a controller capable of capturing an image of a personal identification medium such as an identification card.

The server stores program instructions that, when executed by the processor, implement a set of modules including a prompt generation module, a contract data management module, an image-processing and character-recognition interface module, a personal-information extraction module, a multilingual user-interface module, and a voice-processing interface module. The server also stores a contract data structure in a database system such as a relational database management system. The contract data structure is defined as a schema including, for example, fields for contract identifier, user identifier, service identifier, personal identification number, name, address, date of birth, contract state, language code, and one or more fields for response data and approval data.

The terminal executes client software, such as a web browser or a native application, which communicates with the server using a transport protocol and application-layer protocol. The terminal also communicates with the image acquisition apparatus using a device driver interface, such as a scanner driver interface or a camera application programming interface. In one implementation, the terminal uses a driver conforming to a standardized scanner protocol to obtain image data from a flatbed scanner or a document scanner. In another implementation, the terminal uses a camera module integrated into a portable information processing apparatus to capture an image of the personal identification medium.

The server uses the prompt generation module to generate machine-readable instructions that guide the terminal. The terminal interprets these instructions and presents user-facing display information on the display. The server defines a prompt as a structured record containing at least a prompt type, a text resource identifier, a target operation, and optional parameters such as language code and layout hints. The multilingual user-interface module loads language resources stored as key-value mapping files, for example message bundles or localization tables. The server uses an internationalization framework to resolve text resource identifiers to concrete strings in a selected language and transmits these strings to the terminal. The terminal renders the text strings, icons, and input controls so that the user can understand which service to select, how to place the identification medium, and how to confirm extracted information.

The server causes the terminal to control the image acquisition apparatus and obtain image data of the personal identification medium. The terminal receives raw image samples from the image acquisition apparatus and converts them into encoded image data such as an image in a compressed or uncompressed format. The terminal may perform preliminary processing such as rotation correction, cropping to a predetermined aspect ratio, and resolution normalization. By performing this processing at the terminal, the system reduces the bandwidth required to transmit the image to the server and standardizes the input format for subsequent processing within the server.

The server receives the image data from the terminal via the network interface and stores the image data in a file system or object storage. The image-processing and character-recognition interface module then supplies the stored image data to a character-recognition processing unit. In one embodiment, the character-recognition processing unit is implemented by an optical character recognition engine executed on the same hardware as the server. In another embodiment, the character-recognition processing unit is provided as a remote network service and is accessed via a web service interface. The server packages the image data into a request message, transmits the request message to the character-recognition processing unit, and receives the recognition result as structured textual data including recognized character sequences, positional information, and confidence scores.

The server uses the personal-information extraction module to analyze the recognition result. The personal-information extraction module implements both deterministic rule-based logic and learned models. In one embodiment, the personal-information extraction module uses a layout-aware parser that takes as input (i) recognized text segments, each with coordinates in the image space, and (ii) prior knowledge of expected label positions on a specific category of personal identification medium. The server uses a mapping table that defines, for each expected field such as name, address, and date of birth, a geometric region or relative position pattern. The server compares the coordinates of recognized text segments with these regions to associate segments with semantic fields.

In another embodiment, the personal-information extraction module uses a learned classifier based on a neural network. The server implements, for example, a sequence-tagging model such as a bidirectional recurrent neural network, a convolutional neural network, or a transformer-based architecture. The server encodes each recognized text token into a feature vector including token content, character n-gram features, position features, and confidence scores. The server feeds the feature vectors into the neural network, which has been trained to output field labels such as NAME, ADDRESS, DATE_OF_BIRTH, or ID_NUMBER. The server trains this neural network offline using a dataset of labeled identification card images and corresponding OCR text, applies a loss function such as cross-entropy over the sequence of labels, and updates model parameters using a gradient-based optimization method. During training, the server applies data augmentation such as random rotation, scaling, and noise injection to the input images in order to improve robustness to real-world scanning conditions. By using positional features, confidence features, and sequence context, the neural network can distinguish between similar text patterns and map them to correct contract fields with higher accuracy than simple string matching.

The server normalizes the extracted values by applying predefined formatting rules. For example, the server converts date strings to a unified date format, removes extraneous characters from identification numbers, and converts full-width characters to half-width characters when appropriate. The server maintains per-field validation logic, implemented by pattern matching or rule evaluation, to detect anomalies such as invalid date ranges or impossible identification number check digits. The server assigns a field-specific confidence value based on both the character-recognition confidence and the classification confidence, and stores this confidence value in the contract data structure.

The server uses the contract data management module to automatically populate the contract data structure with the normalized personal information. The server maintains a schema mapping table that maps each semantic field such as NAME or ADDRESS to a specific column or attribute in the contract data structure. The server writes the extracted and normalized values into the corresponding fields and marks each field with a source attribute indicating that the value originates from character-recognition processing. By structuring the data in this way, the server can automatically track which fields are populated by machine extraction and which fields are later modified or confirmed by the user.

The server then causes the populated contract data structure to be presented on the terminal. The server transmits the contract data structure, including field values, confidence values, and source indicators, to the terminal. The terminal displays the contract items in a user interface that highlights fields with low confidence by using distinct colors or markers. The user views each field and, where necessary, uses the input device of the terminal to correct or supplement the field value. The terminal transmits any corrections back to the server. The server updates the contract data structure accordingly and logs the changes in an audit log that records, for each field, the original extracted value, the corrected value, the time of correction, and an identifier of the session.

The server also supports voice-based interaction. The server uses the voice-processing interface module to cause the terminal to activate its audio acquisition function and obtain voice input from the user. The terminal records the voice input and transmits corresponding audio data to the server or to a speech-recognition processing unit. The speech-recognition processing unit may be implemented by a neural-network-based automatic speech recognition system. In one embodiment, the system uses an acoustic model based on a convolutional and recurrent neural network that maps audio feature sequences, such as Mel-frequency cepstral coefficients, to phoneme or subword tokens, and a language model that predicts likely word sequences. The system trains the acoustic model using a loss function such as connectionist temporal classification and optimizes the model parameters using stochastic gradient descent. The server receives recognized text output and uses it as response data or approval data. For example, when the user speaks a phrase indicating consent, the server compares the recognized text against one or more predefined approval patterns and, if matched, stores a corresponding approval flag in the contract data structure together with a reference to the audio recording for audit purposes.

The server further provides multilingual interaction. The multilingual user-interface module stores language resources for multiple languages and associates each resource with a language code. When the terminal indicates a language setting, the server selects appropriate resources and generates prompts and labels accordingly. The server uses the same structural representation of prompts and contract fields regardless of language and only changes the mapping from resource identifiers to language-specific text. This design allows the server to maintain a single contract logic path while providing localized user-facing display information, thereby reducing duplication of logic and improving maintainability.

The system can be used in various application scenarios. For example, the user may use a terminal in a communication service store to sign up for a communication service plan. The server guides the user to scan an identification medium using a document scanner. The server performs character recognition and personal-information extraction as described above and automatically fills a contract data structure with the user's name, address, and date of birth. The user then reviews the automatically filled form on the terminal, corrects any mistakes, and finally approves the contract by selecting an approval control or by providing a spoken confirmation that is recognized as approval data.

As another example, the user may use a personal computer or a portable terminal at home. The user accesses a contract portal provided by the server and scans an identification medium using a camera integrated into the portable terminal. The server receives the image, executes character recognition and neural-network-based field classification, and generates a contract data structure. The server then presents a multilingual interface to the user based on the terminal's language setting, and the user interacts with the system in a preferred language.

The system can also interact with a generative AI model for descriptive explanation or support of the contract process, although the generative AI model is not required for core contract creation. The user may input a prompt sentence such as “Explain a system in which a server uses OCR to extract personal information from a scanned driver's license and automatically fill in the forms required for a new mobile phone contract.” or “Describe, step by step, how a terminal scans an ID card, sends the image to a server, and how the server performs character recognition, foreign language support, and voice recognition to simplify a contract procedure.” The server can transmit this prompt sentence to a separate generative AI model in order to obtain user guidance text or explanatory content. The server does not rely on the generative AI model for the core technical extraction and population mechanisms; instead, the server uses deterministic modules and trained recognition models as described above for the main contract pipeline.

The system improves computer technology in several respects. First, by integrating image acquisition, character recognition, and personal-information extraction into a unified contract data structure under central server control, the system reduces redundant data transfers and repeated validation cycles that occur in conventional systems where users manually retype identification data. The server performs structured extraction and mapping in one or a small number of passes, which reduces the number of client-server round trips and database writes. This reduction in communication and processing overhead improves throughput and scalability of the contract system.

Second, by using a specialized neural-network-based personal-information extraction module that considers positional information, recognition confidence, and sequence context, the server increases the accuracy and robustness of field mapping compared with conventional rule-only approaches or manual input. The higher accuracy reduces the frequency of user corrections and minimizes inconsistent states between the image of the identification medium and the contract data structure. The system thereby reduces error rates and enhances data integrity in the backend storage.

Third, by encoding contract information in a structured contract data structure with explicit source and confidence attributes for each field, the system enables the server to apply targeted validation and correction prompts only where needed. The server can, for example, highlight only low-confidence fields for user review. This selective highlighting reduces information overload for the user and decreases the number of pages or dialogs that need to be re-rendered, which leads to faster interaction and lower resource consumption on both the server and the terminal.

Fourth, by integrating voice input as a first-class data source using a speech-recognition processing unit, the system provides an additional input modality that can be used even when text typing is difficult. The server treats voice-derived character data using the same contract data structure as typed text, which simplifies the software architecture and reduces the need for separate, ad-hoc integration layers. This unified processing path improves maintainability and reduces the risk of inconsistent handling of different input modalities.

Fifth, by providing multilingual prompts and display information through a resource-based localization framework controlled by the server, the system avoids the need to maintain separate, language-specific logic branches. The server can generate all user-facing information from a single set of resource identifiers and selection rules, which simplifies the code base and reduces errors arising from duplicated logic. Furthermore, because the language selection is handled as a simple parameter in prompt generation and contract data rendering, the system can switch languages with minimal overhead, improving user experience and system performance.

The system supports various implementation variations. For example, the server may execute the character-recognition processing unit locally, or may delegate character recognition to an external service, while still performing personal-information extraction and contract population locally. The terminal may be a stationary device in a service center, a portable communication device, or a standard personal computer. The image acquisition apparatus may be a dedicated scanner, a camera module, or another imaging sensor suitable for capturing identification media. The speech-recognition processing unit may be hosted on the same hardware as the server or accessed via a network interface.

By defining explicit data structures, algorithms, and neural-network architectures for personal-information extraction and contract population, and by integrating these elements into a unified pipeline controlled by the server, the system provides a concrete technical implementation that goes beyond simple automation of human tasks. The system modifies how the computer manages and processes input signals, image data, linguistic data, and contract records to achieve improved speed, accuracy, and resource efficiency in contract creation and management.

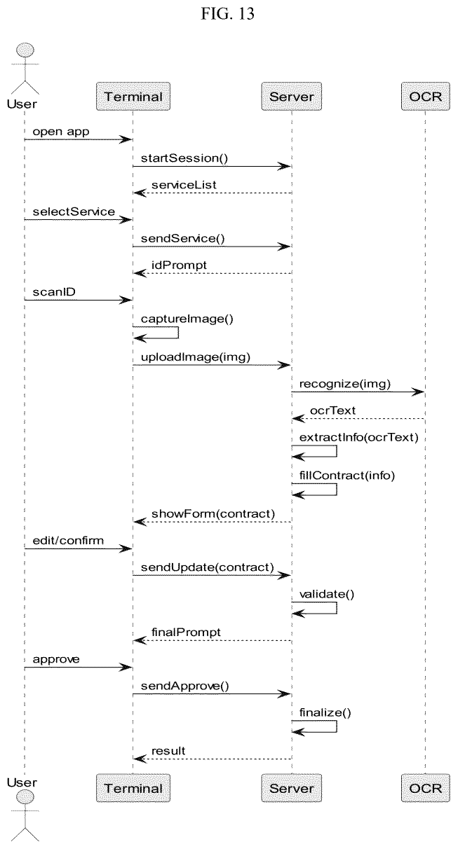

The following describes the processing flow using FIG. 13.

### Step 1:

The user activates a client application on the terminal and initiates access to the contract service.

The terminal sends a connection request including device information and a language preference to the server.

The server receives the request as input, allocates a new session identifier, and writes an initial session record into a session store. The server accesses a service catalog stored in a database, filters available services according to configuration rules, and generates a service list as output. The server transmits the service list and the session identifier to the terminal.

### Step 2:

The terminal receives the service list as input and renders selectable service options on a display.

The user reviews the displayed options and selects at least one contract-target service using an input device.

The terminal collects the selected service identifier and the session identifier as input and generates a selection message. The terminal sends this message to the server and thereby outputs structured selection data including the chosen service identifier and any selected options.

### Step 3:

The server receives the selection data as input and validates that the selected service identifier exists in the service catalog.

The server queries the database to obtain service attributes such as required personal information fields and default contract terms. The server instantiates a contract data structure in memory, initializes fields related to the selected service, assigns a temporary contract identifier, and sets the contract state to a draft state. The server stores this contract data structure in persistent storage and outputs a response containing service details and guidance for identity verification to the terminal.

### Step 4:

The terminal receives the guidance for identity verification as input and displays prompts instructing the user to prepare a personal identification medium.

The user places the personal identification medium on or in proximity to an image acquisition apparatus and confirms readiness by operating a control on the terminal.

The terminal receives the user's confirmation and issues a control command to the image acquisition apparatus as output, thereby starting an image capture operation.

### Step 5:

The image acquisition apparatus captures an image of the personal identification medium and transmits raw image samples to the terminal.

The terminal receives the raw samples as input and performs image preprocessing operations such as color space conversion, rotation correction, cropping, and resolution adjustment. The terminal encodes the processed image into image data in a predefined format and associates metadata such as resolution and timestamp. The terminal outputs the image data and metadata to the server via a network connection.

### Step 6:

The server receives the image data and metadata as input and performs validation to ensure that the image meets predefined criteria such as format and file size.

The server stores the validated image data in a storage subsystem and generates a storage reference key. The server passes the storage reference key and the image data to a character-recognition processing unit. The server outputs an OCR request containing the image data and processing parameters such as expected language and region of interest definitions.

### Step 7:

The character-recognition processing unit receives the ocr request as input and analyzes the image data.

The character-recognition processing unit segments the image into text regions, extracts character shapes, and converts the shapes into recognized characters using a trained recognition model. The character-recognition processing unit computes confidence scores for each recognized text segment and outputs an OCR result containing text strings, positional coordinates, and confidence values to the server.

### Step 8:

The server receives the OCR result as input and passes it to a personal-information extraction module.

The server applies rule-based logic and, in certain embodiments, a neural-network-based classifier to map each recognized text segment to a semantic label such as NAME, ADDRESS, DATE_OF_BIRTH, or ID_NUMBER. The server uses positional information, token patterns, and confidence scores as features and executes classification computations to determine the most likely label for each segment. The server outputs a structured personal-information object containing labeled fields and associated confidence values.

### Step 9:

The server receives the structured personal-information object as input and performs normalization of each field.

The server converts date strings into a standardized date format, converts character encodings if needed, removes extraneous symbols from identification numbers, and standardizes address components. The server runs validation checks by applying pattern matching and range checks on the normalized fields. The server updates the contract data structure by writing the normalized values into corresponding fields and tagging each field with a source attribute indicating that the value originates from character recognition. The server outputs an updated contract data structure stored in association with the current session.

### Step 10:

The server receives the session context as input and invokes a prompt generation module to create user-facing prompts for confirmation.

The server loads language resources based on a language setting associated with the session and resolves resource keys for field labels, warnings, and guidance messages. The server embeds the field values, confidence indicators, and localized text into a response payload. The server outputs the response payload to the terminal to cause presentation of the populated contract data structure.

### Step 11:

The terminal receives the response payload as input and renders a contract confirmation interface.

The terminal displays each contract field value, including the user's name, address, date of birth, and service details, and visually marks fields with low confidence by using indicators such as color or icons. The user inspects the displayed values and, when necessary, edits individual fields via the input device. The terminal aggregates modified field values and a list of edited fields into correction data and outputs the correction data to the server.

### Step 12:

The server receives the correction data as input and updates the contract data structure accordingly.

The server overwrites prior field values with corrected values, changes the source attribute for edited fields to indicate manual confirmation, and writes change records into an audit log. The server checks that all mandatory fields are present and valid by executing consistency checks and referential integrity rules. If the contract data structure passes validation, the server sets an internal flag indicating readiness for final approval and outputs an updated confirmation prompt to the terminal.

### Step 13:

The terminal receives the updated confirmation prompt as input and presents a final approval control to the user.

The user performs a final approval operation by selecting an on-screen control or, in certain embodiments, by providing a voice command that is recognized as an approval phrase. The terminal converts the operation or the recognized phrase into an approval message and outputs the approval message, including the session identifier, to the server.

### Step 14:

The server receives the approval message as input and verifies that the contract data structure associated with the session is in a ready state.

The server changes the contract state from the draft state to a confirmed state or an active state and assigns a permanent contract identifier. The server stores the finalized contract data structure in persistent storage and, optionally, triggers generation of a contract document and transmission of a confirmation notification. The server outputs an acknowledgment containing the contract identifier and state information to the terminal.

### Step 15:

The terminal receives the acknowledgment as input and updates the user interface to indicate successful contract completion.

The terminal displays the contract identifier, a summary of the finalized contract, and any next-step information. The user views the completion screen and may close the application or proceed to additional operations. The terminal outputs a termination signal or session end indication to the server, enabling the server to release associated session resources.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional service recommendation and contracting systems implemented on general-purpose computers typically rely on fixed, manually designed question flows, static rule engines for plan calculation, and separate, loosely integrated modules for language processing and user-identification. As a result, the overall system suffers from several technical limitations at the computing level.

First, the processor must execute multiple heterogeneous application programs (for example, a UI engine, a rules engine, a form engine, and a separate workflow engine) in a sequential and often redundant manner. This leads to increased CPU cycles, repeated data transformations, and inefficient use of memory caches, particularly when complex branching questionnaires are implemented for different service categories. Because the questions are hard-coded, the processor cannot easily adapt the question flow to diverse users, causing unnecessary computations and data transfers for questions that are irrelevant to a given user profile.

Second, when multilingual support and voice input are added, conventional architectures typically bolt on separate speech recognition, translation, and rendering components as independent services. A central processor must orchestrate these services through multiple network round-trips, converting formats and protocols for each service. This increases end-to-end latency, increases the number of context switches and buffer copies within the server, and deteriorates responsiveness from the standpoint of the user. Moreover, static prompts cannot be adapted efficiently to different languages and modalities, and the processor executes redundant rendering paths for each language and modality.

Third, in systems that require identity verification and contract finalization, conventional architectures frequently handle image capture, optical character recognition (OCR), data extraction, and contract form population in separate stages and sometimes on different machines. The central processor is required to marshal large image payloads back and forth between services, to maintain multiple intermediate representations of the same data, and to repeatedly parse and validate partially filled forms. This results in additional network overhead, increased memory pressure, and a higher chance of inconsistency in the contract data.

Fourth, although emotion analysis and personalization techniques exist, they are often implemented as ancillary analytics modules that are not integrated into the core decision loop of the service recommendation engine. The processor may perform offline emotion inference or log-only analysis, but does not use emotional state as a first-class parameter in the runtime selection and ranking of service candidates. As a consequence, the processor wastes computation on generating and presenting options that are mismatched to the user's current cognitive state (for example, detailed and complex plans when the user appears confused), and then performs further unnecessary UI and network processing when the user abandons or restarts the flow.

Fifth, the use of generative artificial intelligence models in existing systems is typically limited to content generation in isolation from the core transaction logic. The processor may call a generative model to generate marketing text or FAQs, but does not use the generative model to dynamically generate prompt sentences that control both the question flow and the explanation of computed results in a unified way. As a result, the processor must maintain separate logic for UI templates, branching flows, and natural-language messages, leading to duplicated state machines, increased code complexity, and error-prone synchronization between the computational state (conditions and fees) and the natural-language state (what is displayed to the user).

Accordingly, there is a need for an improved computer-implemented system architecture in which a processor:
(1) centrally orchestrates user interaction, question generation, computation of service conditions and fees, and contract finalization using a unified prompt-based control layer driven by a generative artificial intelligence model;
(2) tightly integrates OCR-based identity extraction, multilingual speech and text processing, and emotion analysis into the main computational path, thereby reducing redundant data movement, format conversions, and network calls;
(3) uses the estimated emotional state of the user and the user's answers as direct parameters in the runtime selection, modification, and narrowing of service candidates, thereby avoiding unnecessary generation and rendering of unsuitable options; and
(4) generates natural-language prompt sentences that simultaneously control generative question creation, explanation of computed results, and presentation of recommendations across multiple languages and modalities, thus simplifying the internal state machine and reducing computational overhead for UI management.

By solving these technical problems at the level of how the processor structures, sequences, and integrates these operations, the invention aims to improve the efficiency, responsiveness, robustness, and adaptability of computer systems that provide interactive service recommendation and contract completion functions.

The specific processing by the specific processing unit 290 of the data processing device 12 in Application Example 2 is realized by the following means.

The present invention provides a server comprising a processor configured to generate, and cause a communication terminal to display, prompt sentences that instruct a user to select a classification item via an information processing device; to determine, based on the selected classification item, a plurality of related questions, to generate prompt sentences for a generative artificial intelligence model so as to cause the generative artificial intelligence model to generate the plurality of questions in natural language, and to cause the communication terminal to present the plurality of questions; to compute, based on answer data acquired from the user, conditions and fees of a service, to generate natural-language prompt sentences explaining computation results, and to cause the communication terminal to display the computation results; to generate prompt sentences for the generative artificial intelligence model based on the selected classification item and the answer data so as to cause the generative artificial intelligence model to generate one or more service candidates suitable for the user, and to present the one or more service candidates; to acquire image data of an identification medium obtained by an imaging device or an image acquisition device of the communication terminal, to execute character-recognition processing on the image data to extract personal information, and to automatically input contract information based on the extracted personal information; to analyze image data and audio data acquired from the imaging device and an audio acquisition device of the communication terminal, or text input data of the user, in order to estimate an emotional state of the user as emotion analysis; to modify or narrow down the one or more service candidates based on the emotional state and the answer data, and to recommend a service suitable for the user; and to, in response to a confirmation input of contract contents by the user, record the contract information and finalize completion of a contract. This enables the server to implement, within a unified computational framework, dynamic and emotion-aware control of user interaction, multilingual prompt generation, service computation, identity extraction, and contract finalization, thereby reducing redundant data transfers and processing steps, decreasing latency, simplifying internal control logic, and improving overall efficiency and responsiveness of the computer system.

The term “system” refers to a combination of one or more computing devices, storage devices, and communication interfaces that cooperate to execute the processing defined in the claims.

The term “server” refers to an information processing apparatus including at least one processor and memory, configured to provide computational functions and data services to one or more client devices over a communication network.

The term “processor” refers to one or more hardware processing units, such as central processing units, graphics processing units, or dedicated accelerators, configured to execute machine-readable instructions to perform logical operations, data processing, and control of peripheral devices.

The term “communication terminal” refers to an electronic device operated by a user, such as a mobile device, a tablet device, a personal computer, or a wearable device, that is capable of communicating with the server over a communication network and presenting information to the user.

The term “information processing device” refers to a generalized computing apparatus, including the communication terminal and/or other client-side hardware, that processes input data from the user and exchanges information with the server.

The term “prompt sentence” refers to natural-language text generated by the processor and used to instruct, guide, or query a user or a generative artificial intelligence model in the context of an interaction sequence.

The term “classification item” refers to an abstract category or class selectable by the user, which is used by the processor to determine a domain of services or information and to control subsequent question generation.

The term “question” refers to a natural-language inquiry generated or selected by the processor and presented to the user in order to obtain answer data relevant to service selection, condition determination, or contract processing.

The term “answer data” refers to structured or unstructured data representing responses provided by the user to one or more questions, including text input, selection input, or other interaction events.

The term “service” refers to a provided functionality, operation, or benefit that can be offered to the user under defined conditions and fees, including but not limited to digital services, communication services, and content provision.

The term “condition” refers to a parameter, constraint, or rule governing usage of a service, such as a limitation, a term, a threshold, or a requirement associated with service provision.

The term “fee” refers to a monetary amount or other cost measure associated with the usage of a service under specified conditions.

The term “generative artificial intelligence model” refers to a machine-learned model, such as a neural network-based language model, configured to generate natural-language text or other structured outputs in response to input prompt sentences.

The term “identification medium” refers to a physical or electronic carrier that includes data uniquely identifying a person, such as a government-issued identification card, a personal identification card, or an equivalent credential medium.

The term “image data” refers to digital data representing visual information, including still images or video frames, obtained by an imaging device or other image acquisition component.

The term “imaging device” refers to a hardware component capable of capturing visual information and converting it into digital image data, such as a camera module or an image sensor.

The term “image acquisition device” refers to any device or subsystem that obtains or provides image data to the processor, including scanners, cameras, or equivalent image-capturing hardware.

The term “character recognition processing” refers to a computational procedure that analyzes image data to detect and recognize characters or symbols and converts them into machine-readable text data.

The term “personal information” refers to data items that can identify or describe an individual, such as a name, an address, a date of birth, an identification number, or other comparable attributes.

The term “contract information” refers to structured data that defines the terms, parties, conditions, and identifiers of a contract between the user and a service provider.

The term “audio data” refers to digital data representing sound, including voice signals captured from the user by an audio acquisition device.

The term “audio acquisition device” refers to a hardware component configured to capture sound and convert it into digital audio data, such as a microphone or an audio input module.

The term “text input data” refers to digital data representing textual content explicitly entered by the user, for example via a keyboard, a touch interface, or a speech-to-text conversion component.

The term “emotional state” refers to a representation of a psychological condition of the user, such as happiness, confusion, stress, or similar affective states, as estimated by the processor from input data.

The term “emotion analysis” refers to processing operations that analyze image data, audio data, or text input data to infer or estimate an emotional state of the user.

The term “service candidate” refers to a potential service option or plan generated or selected by the processor as a possible match for the user's needs and preferences.

The term “recommendation” refers to the act of selecting one or more service candidates and presenting them to the user as suggested options based on computed criteria and estimated emotional state.

The term “confirmation input” refers to user-provided input that indicates acceptance or approval of contract contents, such as an explicit selection, a signature action, or a confirmation command.

The term “language type” refers to an attribute indicating the natural language associated with text data, such as a language code or identifier used to select translation and generation behavior.

The term “speech recognition processing” refers to computational operations that convert audio data representing spoken language into corresponding text data.

The term “translation processing” refers to computational operations that convert text data expressed in one natural language into text data expressed in another natural language.

The term “explanation sentence” refers to a natural-language sentence generated by the processor or the generative artificial intelligence model that describes or clarifies conditions, fees, or other service-related information.

The term “guidance sentence” refers to a natural-language sentence generated by the processor or the generative artificial intelligence model that directs or assists the user in performing a next action, understanding an option, or navigating a process.

In one embodiment, a server, a terminal, and a user cooperate to implement the claimed system. The server includes at least one processor, a main memory, a non-volatile storage device, and a network interface. The terminal includes at least one processor, a display, an input unit, an imaging device such as a camera, and an audio acquisition device such as a microphone. The user operates the terminal to interact with the server over a communication network.

The server executes an operating system such as a general-purpose server operating system and runs server-side application software implemented, for example, in a programming language such as a high-level language, on top of an application framework. The server further executes machine-learning libraries such as a tensor computation framework or a neural-network framework, an image-processing library such as a computer-vision library, and client libraries for accessing external cloud services such as speech recognition, translation, and text-to-speech services. The terminal executes a mobile operating system or desktop operating system and a web browser or native application that communicates with the server using a secure protocol such as HTTPS.

The server stores, in the storage device, a set of program modules including at least: a prompt management module, a generative AI interface module, a questionnaire generation module, a plan computation module, a candidate selection module, an OCR processing module, an emotion analysis module, a multilingual processing module, and a contract management module. The server also stores one or more generative artificial intelligence models, emotion classification models, and auxiliary models, or accesses such models via external inference services.

The server uses a generative AI model that, in one embodiment, is a transformer-based sequence model having multiple attention layers, feed-forward layers, and layer-normalization components. The server trains this generative AI model in advance on a corpus of domain-specific conversational texts and question-answer pairs. The server configures the generative AI model with parameters including a number of layers (for example, 12 or more transformer blocks), a hidden dimension size (for example, 768 units or more), and a multi-head attention mechanism (for example, 12 heads or more). The server updates the weights of the generative AI model during training using a stochastic gradient descent-based optimizer such as Adam, a cross-entropy loss function over token predictions, and a learning-rate schedule with warm-up and decay. The server optionally applies data augmentation such as paraphrasing, back-translation, or random masking to increase robustness in prompt sentence generation.

The server uses the generative AI model in inference mode to generate prompt sentences and questions. The server constructs a tokenized representation of an input prompt sentence, feeds the tokens into the model, and generates output tokens using an auto-regressive decoding algorithm such as beam search or top-k sampling. The server then detokenizes the output tokens into a natural-language string and uses this string as a prompt sentence or as a question presented to the user.

The server implements a specific data structure to maintain interaction state. In one embodiment, the server maintains a session object for each user that includes at least the following fields: a classification item identifier, a list of generated questions, a list of answer data objects, a current emotion state vector, a list of service candidates, and a contract state. Each answer data object includes a question identifier, a raw response string, optional numerical features extracted from the response, and a timestamp. Each service candidate includes a structured description of conditions and fees and a reference to a plan template in a relational database.

The server uses a plan computation module that executes deterministic algorithms on the answer data. The server implements rule sets in the form of if-then rules and parameterized formulas stored in database tables. For example, the server maintains a tariff table keyed by classification item, budget range, and usage pattern, and a formula table defining how to compute effective fees based on base price, discounts, and surcharges. The server retrieves the relevant rows using indexed queries, and computes conditions and fees by applying vectorized arithmetic operations. This structured approach reduces repeated computation and improves cache locality, thereby decreasing processing time compared to ad-hoc script-based computation.

The server integrates OCR processing to reduce redundant image handling. The server receives image data of an identification medium captured by the terminal. The server applies a pipeline including grayscale conversion, contrast normalization, and region-of-interest detection by using convolutional filters and connected-component analysis implemented with a computer-vision library. The server segments candidate text regions and feeds each region into a character recognition model such as a convolutional neural network. The server maps recognized characters into a text string and applies regular-expression-based parsing and dictionary-based post-correction to extract structured personal information. The server then directly populates the contract information data structure without requiring multiple intermediate form-entry steps. This integration reduces data copies and serialization overhead, and improves both recognition accuracy and throughput.

The server implements emotion analysis using a multimodal model. The server extracts facial features from image data captured by the terminal. In one embodiment, the server uses a convolutional neural network trained on facial-expression datasets to convert a cropped face image into an embedding vector. The server also extracts acoustic features from audio data using a feature-extraction frontend that computes mel-frequency cepstral coefficients (MFCCs), pitch contours, and energy statistics. The server inputs these features into a recurrent neural network or transformer-based encoder trained to classify emotion categories such as joy, confusion, stress, and neutrality. The server further encodes text input data using a language model to obtain a semantic embedding. The server concatenates or otherwise combines these embeddings and feeds them into a fully connected layer or attention-based fusion module that outputs an emotional state vector. The server trains this emotion model with a supervised objective such as categorical cross-entropy over annotated emotion labels and may use data augmentation techniques such as random noise injection in the audio domain or random brightness changes in the image domain.

The server does not merely replicate human decision-making; instead, the server uses the emotional state vector as a direct parameter to control subsequent computation. The server modifies candidate selection by adjusting weights in a ranking function that combines utility features (for example, cost efficiency, feature coverage) and cognitive load features (for example, number of parameters, complexity score). When the server detects confusion or stress, the server increases weights for simplicity-related features and decreases weights for complexity-related features. When the server detects joy and interest, the server allows more complex or premium options to be ranked higher. This selective re-weighting is executed by matrix multiplications and vector operations, enhancing the suitability of recommendations and avoiding unnecessary computation and network usage on options likely to be rejected.

The server uses the generative AI model to control both question generation and explanation generation via prompt sentences that contain structured control marks. For example, the server uses prompt sentences such as:
“The user selected the ‘Telecom’ classification. Generate 5 concise questions to determine the best telecom plan in terms of budget, data volume, and contract duration.”
   or
“Summarize the following plan in simple language for the user: data volume 10 GB per month, total fee 5,000 units of currency per month, no cancellation fee, and included support.”

The server formats these prompt sentences with explicit delimiters and tags that mark different sections such as user intent, domain constraints, and output style. The server parses the AI output by detecting these tags, reducing parsing errors and making the pipeline robust. This structure reduces token length and ambiguity, thereby improving inference speed and reducing the number of required decoding steps in the generative model.

The server integrates multilingual processing by attaching language type information to all internal text objects. The server uses speech recognition services to convert audio data into text. In one embodiment, the server sends audio waveforms to a cloud-based ASR service with language hints. The server receives text data and language codes, and stores them with the internal interaction state. The server uses translation services to convert prompt sentences, generated questions, and explanation sentences between different natural languages. The server minimizes redundant translations by caching translated prompt templates and reusing them when the same patterns occur across sessions. This reduces network traffic and latency for repeated interactions.

The terminal plays an active role in acquiring and presenting data. The terminal captures image data of an identification medium with a camera and compresses it using a codec such as JPEG at a resolution suitable for OCR. The terminal captures audio data using a microphone and compresses it using a codec such as an audio compression format suitable for speech. The terminal renders questions, answers, explanation sentences, and guidance sentences on a display using a graphical user interface framework, and plays audio explanations using a speaker. The terminal may perform preliminary validation of user input, such as checking that required fields are filled, before sending data to the server, thereby avoiding unnecessary network requests.

The user interacts with the system by selecting a classification item, answering questions, and providing confirmation for contract contents. The user may also speak requests, such as “Where is this product?” or “What is the best plan for my budget?”, and the terminal transmits corresponding audio data to the server. The user may be unaware of the internal complexity; however, the system's structure leads to improved responsiveness and better alignment between the output and the user's state.

The server uses the generative AI model to generate answers to user queries as well, not only to generate questions. For example, when the user asks about the location of a product, the server first uses speech recognition and, if necessary, translation to obtain a normalized text representation. The server then queries a product-location database to obtain structured location information. The server constructs a prompt sentence such as:
“You are a store assistant. The user asked: ‘Where is this product?’ Product data: name: Wireless Headphones X, aisle: 3, shelf: B. Answer briefly in the user's language.”

The server feeds this prompt sentence to the generative AI model, receives an answer such as “The product is in aisle 3, shelf B,” and then uses a text-to-speech service to synthesize an audio response. The terminal plays this audio to the user. By embedding structured product data into the prompt sentence, the server ensures that the generative AI model operates within controlled constraints and does not invent nonexistent locations. This controlled prompting improves the reliability and accuracy of natural-language guidance and reduces the need for post-correction logic.

The server can also generate personalized content based on emotional state and historical behavior. For example, when the user says “I'm stressed” while registering for a service, the server recognizes the emotional state as stress and selects service candidates associated with reducing cognitive load. The server constructs a prompt sentence such as:
“The user is stressed and wants to register for a simple plan. Generate a short and reassuring explanation that describes a minimal plan with low complexity and fixed monthly cost.”

The server receives a generated explanation and presents it via the terminal. This use of emotional state allows the server to adapt text complexity and information density dynamically, which conventional template-based systems cannot do without significant manual design.

The server improves computer technology at several levels. By centralizing prompt generation, question generation, condition computation, and explanation generation into a single pipeline controlled by prompt sentences and stateful data structures, the server reduces the number of separate workflow engines, templating systems, and ad-hoc scripts. This simplifies the codebase, reduces the number of database queries and string concatenations, and decreases memory allocations for UI templates. By integrating OCR, speech recognition, translation, and emotion analysis tightly into a single data flow, the server reduces intermediate serialization and deserialization, minimizing latency and network overhead. By using emotional state explicitly in ranking service candidates, the server reduces computational waste on generating and transmitting options that are likely to be rejected, improving efficiency.

The server further improves technical performance by controlling the generative AI model with compact and structured prompt sentences. The server uses special tokens to mark sections within prompts and uses a limited vocabulary of control tokens that the generative AI model is trained to recognize. This design reduces the number of generated tokens required to express a question or an explanation, so that the decoder loop in the transformer model terminates with fewer iterations, decreasing CPU and GPU usage during inference. The server may also adapt decoding parameters (for example, temperature or beam width) based on the desired level of determinism, further reducing branching in the decoding process.

Alternative embodiments are possible. The server may host the generative AI model locally on dedicated hardware accelerators to avoid network latency. The server may use different neural architectures for emotion analysis, such as convolutional-recurrent hybrids or graph-based models that capture inter-feature relationships. The server may use additional sensors on the terminal, such as a depth camera or a physiological sensor, to refine emotion estimation. The terminal may be a fixed kiosk, a vehicle-mounted device, or a wearable device. The communication between the server and the terminal may use different transport protocols or security layers. The models and databases may be distributed across multiple server nodes, and the interaction state may be replicated to increase robustness and scalability.

In each embodiment, however, the server, the terminal, and the user interact in such a way that the generative AI model and prompt sentences are used not merely to automate human tasks, but to restructure the internal computation and data flow of the system. The system reduces redundant processing, improves prediction and recognition accuracy, decreases latency, and improves responsiveness, thereby achieving a technical improvement in computer functionality and in communication between devices and users.

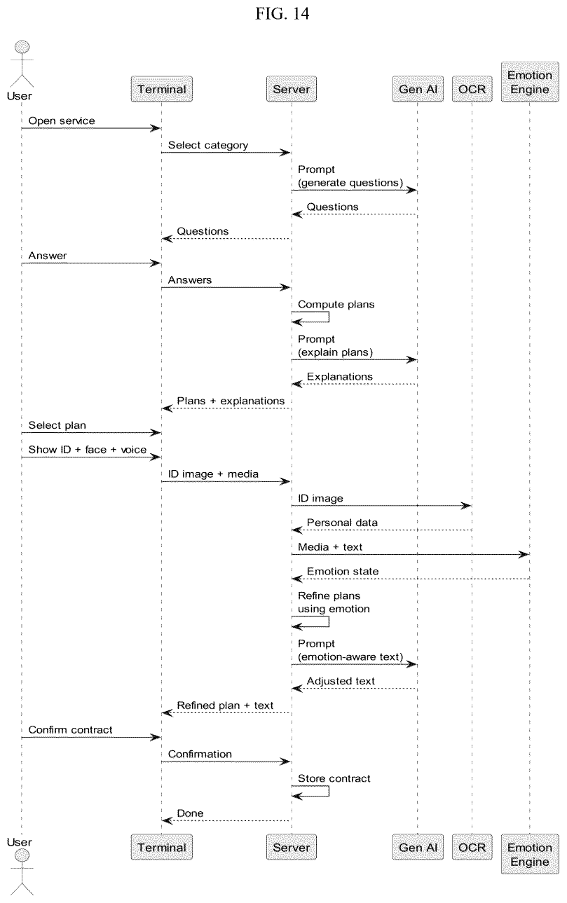

The following describes the processing flow using FIG. 14.

### Step 1:

User operates the terminal to access a service entry screen and select a classification item.

Terminal displays a list of classification items on the display, such as “telecom,” “finance,” or “shopping,” using a graphical user interface.

Input: user touch or click events indicating a selected classification item.

Terminal converts the selected item into a structured value (for example, a category identifier string) and sends this value to the server via a network request.

Output: a request message to the server including the selected classification item as structured data.

### Step 2:

Server receives the selected classification item and generates a prompt sentence for a generative AI model to produce related questions.

Input: the classification item identifier received from the terminal.

Server constructs a prompt sentence in natural language, for example: “The user selected the ‘telecom’ classification. Generate five concise questions to determine the best telecom plan in terms of budget, data usage, and contract duration.”

Server tokenizes this prompt sentence, feeds it to the generative AI model, and executes an inference pass using the model's neural network layers to generate output tokens representing questions.

Server detokenizes the output tokens to obtain a list of natural-language questions.

Output: a structured question list (for example, an array of question strings) associated with the user session.

### Step 3:

Server sends the generated questions to the terminal for display.

Input: the question list generated by the generative AI model in Step 2.

Server encapsulates the question list into a response message formatted for the terminal and transmits it over the communication network.

Terminal receives the response, parses the message, and creates corresponding user-interface elements (for example, text labels, input fields, selection controls) for each question.

Output: display-ready question content rendered on the terminal screen for user interaction.

### Step 4:

User enters answer data for each presented question on the terminal.

Terminal captures user inputs such as typed text, numeric values, multiple-choice selections, or slider positions.

Input: user's interaction events and entered values for all questions.

Terminal aggregates the answers into a structured answer object linking each question identifier to its corresponding user response and attaches metadata such as timestamps.

Terminal transmits the aggregated answer data to the server as a request payload.

Output: a structured answer dataset delivered to the server for processing.

### Step 5:

Server computes conditions and fees of one or more services based on the received answer data.

Input: the structured answer data from the terminal.

Server queries a plan database using keys derived from the answer data (for example, budget range, data usage, contract term).

Server executes arithmetic operations and rule evaluations (for example, applying discounts, surcharges, and thresholds) to calculate service conditions and total fees.

Server assembles the computed values into a structured plan representation, including conditions, fees, and internal plan identifiers.

Output: one or more computed plan objects containing precise conditions and fees.

### Step 6:

Server generates an explanatory prompt sentence to obtain a natural-language explanation of a computed plan from the generative AI model.

Input: the structured plan objects generated in Step 5.

Server creates a prompt sentence, for example: “Summarize the following telecom plan in simple language for the user: data volume 10 GB per month, total fee 5,000 units of currency per month, no cancellation fee, and included customer support.”

Server tokenizes the prompt sentence, passes it through the generative AI model, and decodes the output tokens using an auto-regressive decoding algorithm to produce a concise explanation sentence.

Server associates the explanation sentence with the corresponding plan object.

Output: plan objects enriched with natural-language explanation sentences.

### Step 7:

Server sends the computed plans and their explanations to the terminal for presentation to the user.

Input: plan objects including conditions, fees, and explanation sentences.

Server converts the plan objects into a response format, such as a list of display-ready entries, and transmits the response to the terminal.

Terminal receives and parses the response, creates visual components showing plan names, fees, conditions, and explanation text, and renders them on the display.

Output: a set of visible plan options with human-readable explanations presented on the terminal.

### Step 8:

User reviews the proposed plans on the terminal and selects one or more preferred service candidates.

Input: visual display of plan options with explanations.

User taps or clicks on a plan selection control to indicate a preferred service candidate.

Terminal maps the user's selection to the corresponding internal plan identifier and constructs a selection message.

Terminal sends the selected plan identifier(s) back to the server.

Output: a structured selection record indicating the chosen service candidate(s).

### Step 9:

Terminal activates the imaging device and the audio acquisition device to collect image data and audio data for emotion analysis and identification.

Input: user permission and context indicating that further data acquisition is needed.

Terminal captures image frames of the user's face and, if an identification medium is presented, image data of the identification medium using the camera.

Terminal also records short audio segments of the user speaking, if voice interaction is active.

Terminal compresses the image data (for example, JPEG) and the audio data (for example, compressed speech audio) and packages them into one or more data packets.

Terminal sends the multimedia data to the server.

Output: a combined payload containing face images, identification medium images, and audio recordings delivered to the server.

### Step 10:

Server performs OCR on the identification medium image to extract personal information for contract information auto-filling.

Input: image data of the identification medium obtained in Step 9.

Server applies image pre-processing (grayscale conversion, contrast normalization) and region-of-interest detection using image-processing algorithms.

Server segments text regions and feeds each region to a character-recognition model, converting visual patterns into character codes.

Server concatenates recognized characters into lines of text and applies parsing rules and pattern matching to extract fields such as name, address, date of birth, and identification number.

Server stores the extracted personal information into a contract information data structure associated with the selected plan.

Output: a structured personal information object and an auto-filled contract information record.

### Step 11:

Server performs emotion analysis using the user's face images, audio data, and text input data.

Input: face image data, audio data, and optional text input data from the user.

Server extracts facial features (for example, key facial landmarks and appearance descriptors) from the face images using a convolutional neural network.

Server derives acoustic features (for example, MFCCs, pitch, and energy) from the audio signals and encodes them using a sequence model.

Server embeds text input data using a language encoder to obtain semantic vectors.

Server combines these feature vectors into a single multimodal feature representation and inputs it into an emotion classification network, which outputs probabilities or scores for emotion categories such as joy, confusion, stress, and neutrality.

Server determines an emotional state vector representing the dominant emotion and its intensity.

Output: an emotional state vector and a categorical emotion label associated with the current user session.

### Step 12:

Server modifies or narrows down the service candidates based on the emotional state and the answer data, and generates a new prompt sentence for a generative AI model to produce emotion-aware explanations.

Input: the emotional state vector, the selected plan(s), and the answer data.

Server computes a ranking score for each service candidate by applying a weighting function that incorporates both utility features (for example, cost, feature coverage) and complexity features (for example, number of conditions, length of explanation).

Server dynamically adjusts the weights in the ranking function according to the emotional state (for example, increasing simplicity weight under confusion, increasing premium-option weight under joy).

Server selects one or more service candidates that best fit the user's emotional state and prior answers.

Server constructs a prompt sentence, for example: “The user appears confused. Provide a brief and friendly explanation of the selected plan focusing on simplicity: fixed monthly fee, no penalties, and clear conditions.”

Server inputs this prompt sentence into the generative AI model and obtains an adjusted explanation sentence tailored to the emotional state.

Output: a refined set of service candidates and emotion-adjusted explanation sentences.

### Step 13:

Server sends the refined candidates and adjusted explanations to the terminal for final presentation.

Input: the refined candidates and associated explanation sentences produced in Step 12.

Server packages this data into a response message and transmits it to the terminal.

Terminal receives and parses the response, updates the display to show only the refined candidates, and replaces previous explanations with the emotion-adjusted explanations.

Output: a focused set of recommended services and personalized explanations shown to the user on the terminal.

### Step 14:

User reviews the refined recommendation and confirms contract contents on the terminal.

Input: display of refined recommendations and contract details including auto-filled personal information, conditions, and fees.

User performs a confirmation action, such as tapping a “Confirm contract” button or providing a digital signature input.

Terminal validates that required fields are present and that confirmation has been correctly entered, then transmits a confirmation message to the server together with a reference to the contract information record.

Output: a contract confirmation request delivered to the server.

### Step 15:

Server records the contract information and finalizes completion of the contract.

Input: the confirmation request, the contract information record containing personal information, selected plan conditions, and fees.

Server writes the contract information to persistent storage, assigning a unique contract identifier and recording timestamps and status flags.

Server may generate a confirmation message and optional receipt data.

Server returns a completion response to the terminal indicating that the contract has been successfully finalized.

Output: a stored contract record and a completion response indicating successful contract creation.

### Step 16:

Terminal presents the final contract completion status to the user.

Input: completion response and optional receipt or confirmation details from the server.

Terminal updates the user interface to display a completion message such as “Your contract has been completed successfully” and may present contract identifiers or a download link for contract documents.

Terminal optionally offers next actions, such as “Start using the service” or “View contract details,” to the user.

Output: visual and/or audio confirmation provided to the user that the entire processing flow has been successfully completed.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

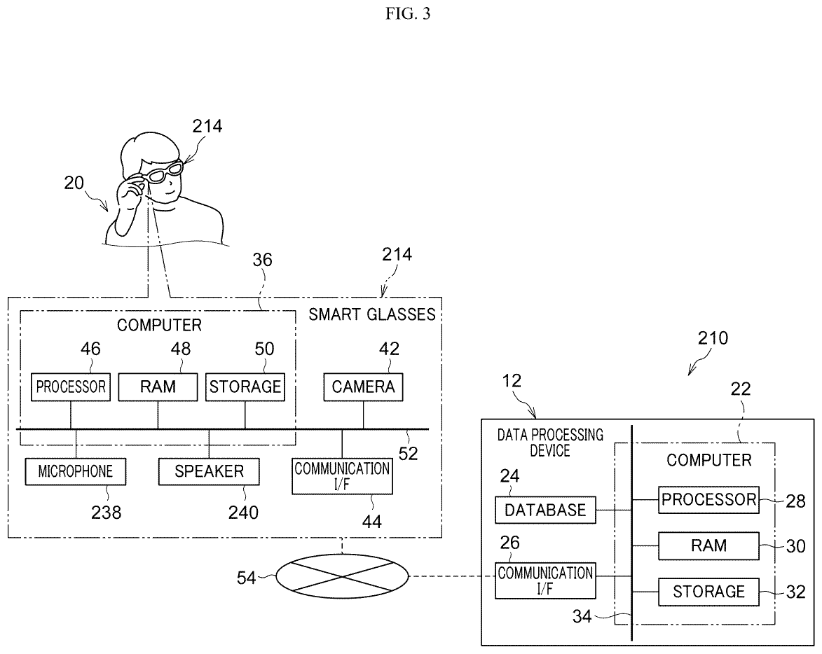

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

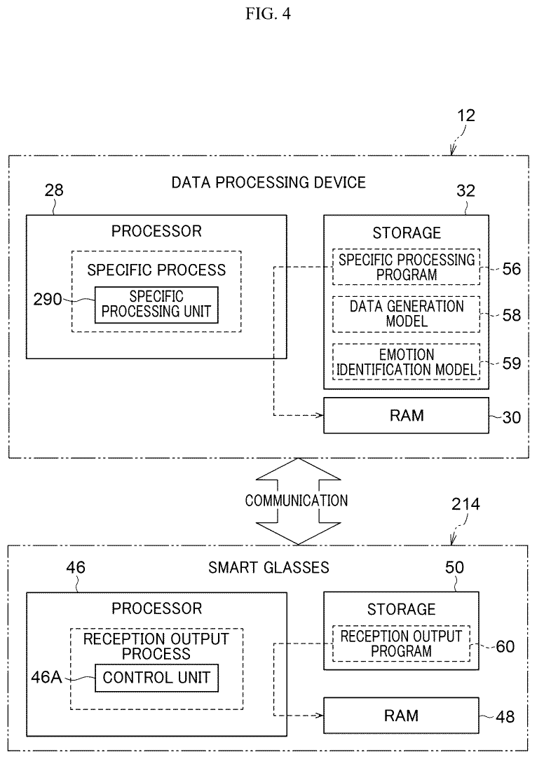

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

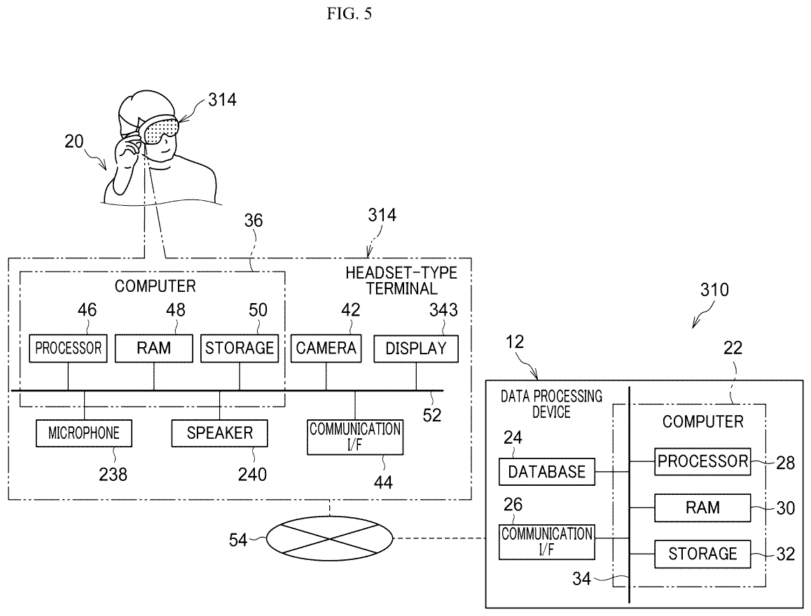

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

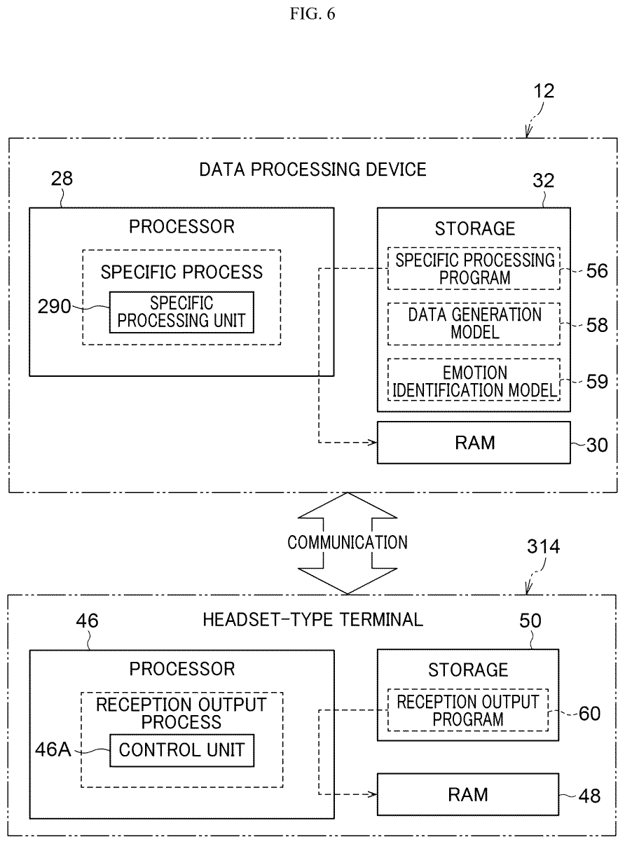

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

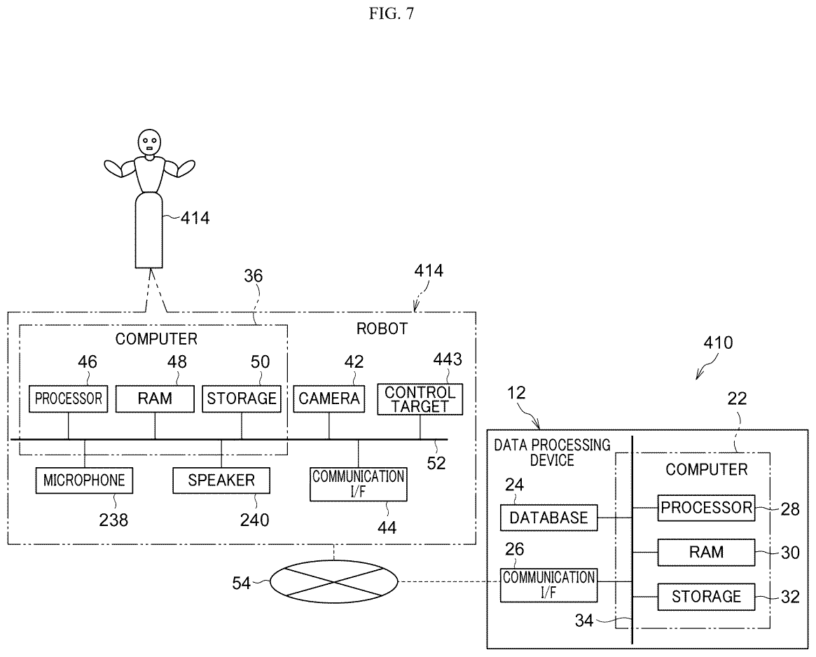

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

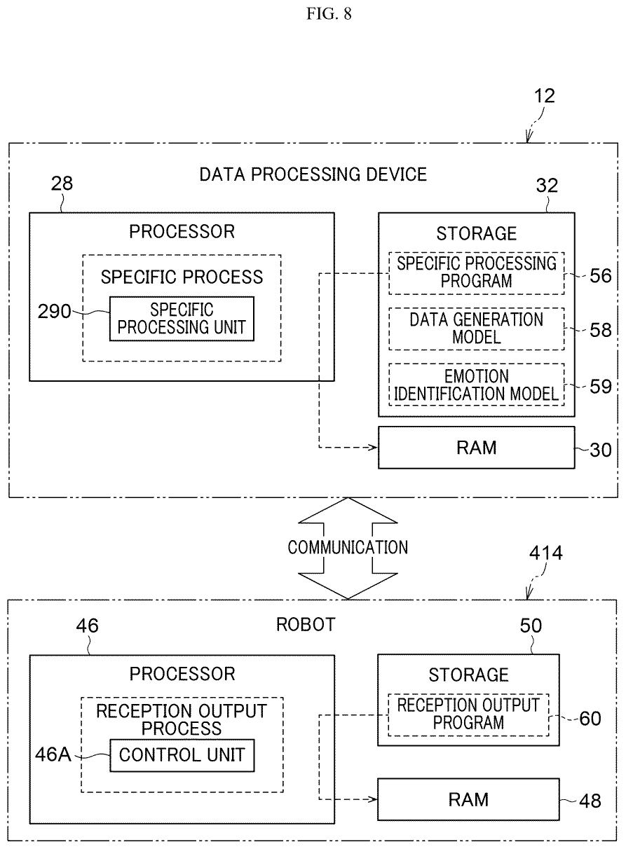

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

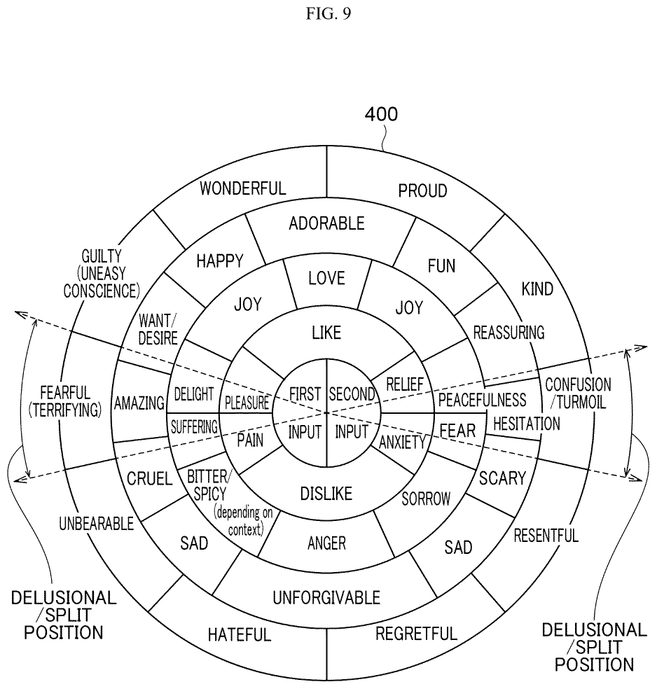

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https: //ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

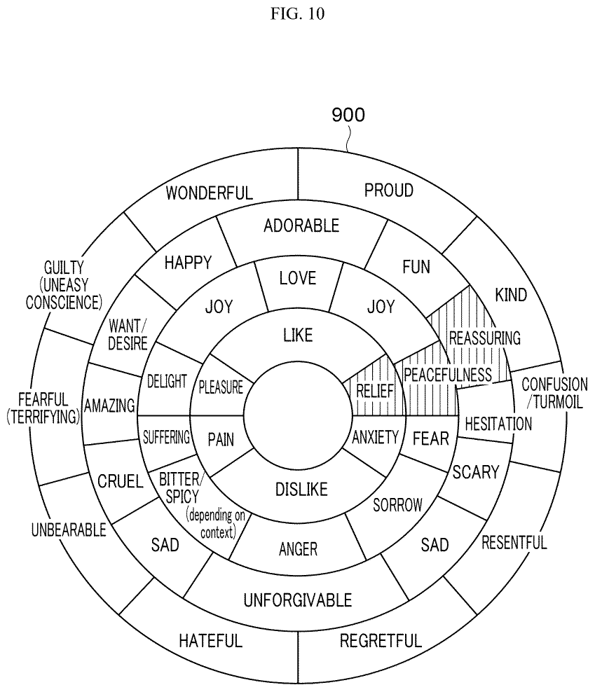

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
cause a terminal apparatus to display guidance information for enabling a user to select classification information on a display screen of the terminal apparatus, and transmit the guidance information to the terminal apparatus,
obtain selection information including the classification information from the terminal apparatus, extract a plurality of inquiry information items associated with the classification information on the basis of stored information or learned information, and generate guidance information for causing the plurality of inquiry information items to be presented by the terminal apparatus, aggregate response information to the plurality of inquiry information items, which is obtained from the terminal apparatus, by using general-purpose tabular information processing software, and, on the basis of the response information, calculate condition information and fee information of service information groups and extract candidate service information,
transmit a prompt sentence including the classification information, the response information, and the candidate service information to a generative AI model so as to cause generation of explanation information concerning the candidate service information, acquire the explanation information from the generative AI model, and construct result information by associating the explanation information with the candidate service information, and
convert the result information into a structured document by using general-purpose template processing software for dynamic document generation, and transmit the structured document to the terminal apparatus so as to cause the structured document to be displayed on a display unit of the terminal apparatus.

### (Supplementary 2)

The system according to supplementary 1,
wherein the processor is configured to
generate character information corresponding to a plurality of language types for the guidance information, the inquiry information, and the explanation information, and select character information corresponding to a language type designated by the user and transmit the selected character information to the terminal apparatus.

### (Supplementary 3)

The system according to supplementary 1,
wherein the processor is configured to
operate voice analysis software in cooperation with a voice acquisition apparatus that acquires voice input of the user for the inquiry information, convert the voice input into character information included in the response information, and extract the candidate service information by using the converted character information.

### Application Example 1

### (Supplementary 1)

A system comprising a processor,
wherein the processor is configured to
receive, via an information processing apparatus, selection information indicating a classification item selected by a user,
generate a prompt sentence for a generative information processing model on the basis of the classification item, cause the generative information processing model to generate a plurality of question sentences related to the classification item by using the prompt sentence, and provide the plurality of question sentences to the user via the information processing apparatus,
acquire response information corresponding to the plurality of question sentences from the user via the information processing apparatus, normalize the response information, and convert the normalized response information into attribute information representing preferences or conditions of the user,
search, on the basis of the attribute information, item information or service information stored in a storage device, calculate a degree of matching between the attribute information and each piece of the item information or the service information, and extract the item information or the service information according to a ranking based on the degree of matching,
calculate or format condition information and fee information included in the extracted item information or the extracted service information, and provide the condition information and the fee information to a display apparatus via the information processing apparatus, and
execute an identification process for the user on the basis of authentication information obtained from an identification medium, and register contract information relating to the extracted item information or the extracted service information in a recording device.

### (Supplementary 2)

The system according to supplementary 1,
wherein the processor is configured to switch a language type of the prompt sentence for the generative information processing model in accordance with a selection by the user, and to cause the generative information processing model to generate the plurality of question sentences in a plurality of languages.

### (Supplementary 3)

The system according to supplementary 1,
wherein the processor is configured to convert voice information acquired from a voice input/output apparatus into character information by voice recognition processing, and to enable at least one of the plurality of question sentences and the response information of the user to be transmitted and received on a voice basis.

### Example 2

### (Supplementary 1)

A system comprising a processor,
wherein the processor is configured to
generate a prompt for causing a user to select, via an information processing apparatus, contract-target information representing a service to be contracted,
generate a prompt for causing the user to read a personal identification medium by an image acquisition apparatus and to acquire image data associated with the personal identification medium,
generate a prompt for causing the image data to be transmitted from the information processing apparatus and for causing a character-recognition processing unit to extract personal information from the image data,
generate a prompt for causing extracted personal information to be automatically input into predetermined items of a contract data structure corresponding to the contract-target information selected by the user,
generate a prompt for causing the automatically-input contract data structure to be presented on the information processing apparatus and for accepting confirmation and correction by the user, and
generate a prompt for causing the contract data structure to be finalized and a contract state to be updated in response to a final approval operation by the user.

### (Supplementary 2)

The system according to supplementary 1,
wherein the processor is configured to
generate the prompt as user-facing display information in a plurality of languages and to switch the display information based on a language setting of the information processing apparatus.

### (Supplementary 3)

The system according to supplementary 1,
wherein the processor is configured to
cause the information processing apparatus to acquire voice input of the user by using an audio acquisition function, to convert the voice input into character data by a speech-recognition processing unit, and to process the converted character data as response data or approval data in the contract data structure.

### Application Example 2

### (Supplementary 1)

A system comprising a processor,
wherein the processor is configured to generate, and cause a communication terminal to display, a prompt sentence that instructs a user to select a classification item via an information processing device,
wherein the processor is configured to determine a plurality of related questions based on the selected classification item, to generate a prompt sentence for a generative artificial intelligence model so as to cause the generative artificial intelligence model to generate the plurality of questions in natural language, and to cause the communication terminal to present the plurality of questions,
wherein the processor is configured to compute conditions and fees of a service based on answer data acquired from the user, to generate a natural language prompt sentence that explains a computation result, and to cause the communication terminal to display the computation result,
wherein the processor is configured to generate a prompt sentence for the generative artificial intelligence model based on the selected classification item and the answer data so as to cause the generative artificial intelligence model to generate one or more service candidates suitable for the user, and to present the one or more service candidates,
wherein the processor is configured to acquire image data of an identification medium obtained by an imaging device or an image acquisition device of the communication terminal, to execute character recognition processing on the image data so as to extract personal information, and to automatically input contract information based on the extracted personal information,
wherein the processor is configured to analyze image data and audio data acquired from the imaging device and an audio acquisition device of the communication terminal, or text input data of the user, and to estimate an emotional state of the user as emotion analysis,
wherein the processor is configured to modify or narrow down the one or more service candidates based on the emotional state and the answer data, and to recommend a service suitable for the user, and
wherein the processor is configured to, in response to a confirmation input of contract contents by the user, record the contract information and finalize completion of a contract.

### (Supplementary 2)

The system according to supplementary 1,
wherein the processor is configured to convert audio data acquired from the user into text data by speech recognition processing, to determine a language type of the text data, to perform translation processing so as to mutually convert the prompt sentence, the questions, the computation result, and recommendation content between different languages, and to generate a prompt sentence for the generative artificial intelligence model in a natural language corresponding to the language type.

### (Supplementary 3)

The system according to supplementary 1,
wherein the processor is configured to generate and supply to the generative artificial intelligence model a prompt sentence including information relating to the emotional state of the user and the one or more service candidates, to cause the generative artificial intelligence model to generate an explanation sentence or guidance sentence adjusted in accordance with the emotional state, and to cause the communication terminal to present the explanation sentence or the guidance sentence.

What is claimed is:

1. A system comprising:
circuitry configured to:
receive, via a communication interface coupled to a packet-switched network, selection data indicating a classification parameter selected at a terminal device;
retrieve, based on the classification parameter, a plurality of inquiry data items associated with the classification parameter from a data store;
transmit the plurality of inquiry data items to the terminal device for presentation;
receive response data corresponding to the plurality of inquiry data items from the terminal device;
aggregate and evaluate the response data using a tabular data-processing engine to compute attribute values for a plurality of candidate data records stored in the data store;
extract, based on the computed attribute values, one or more candidate data records satisfying threshold criteria;
construct a prompt comprising at least the classification parameter, the response data, and the one or more candidate data records;
transmit the prompt to a neural network generative model and obtain explanation data generated by the neural network generative model;
associate the explanation data with the one or more candidate data records to form result data; and
convert the result data into a structured output document using a template processing engine and transmit the structured output document to the terminal device via the communication interface.

2. The system according to claim 1, wherein the tabular data-processing engine performs vectorized arithmetic operations on columns of the plurality of candidate data records to compute at least one of a total cost metric, a cost-per-unit metric, and a weighted score combining a plurality of normalized attribute values.

3. The system according to claim 2, wherein extracting the one or more candidate data records comprises sorting the plurality of candidate data records by the weighted score and selecting a predetermined number of top-ranked records.

4. The system according to claim 3, wherein the prompt further encodes, for each of the one or more candidate data records, a structured set of attribute labels and corresponding values in a predetermined ordering to enable attention-based alignment within the neural network generative model.

5. The system according to claim 4, wherein the neural network generative model comprises a transformer architecture having a plurality of self-attention layers, feed-forward layers, and layer normalization components, and wherein the circuitry obtains the explanation data by auto-regressive token decoding of an output sequence conditioned on the prompt.

6. The system according to claim 1, wherein the circuitry is further configured to:
generate character data corresponding to a plurality of language types for the inquiry data items and the explanation data; and
select character data corresponding to a language type designated by the terminal device and incorporate the selected character data into the structured output document.

7. The system according to claim 1, wherein the circuitry is further configured to:
receive audio data captured by an audio acquisition component of the terminal device;
convert the audio data into character data using a speech recognition engine; and
normalize the character data and incorporate the normalized character data into the response data for processing by the tabular data-processing engine.

8. The system according to claim 1, wherein the circuitry is further configured to:
generate, based on the classification parameter, a prompt sentence for the neural network generative model;
cause the neural network generative model to generate the plurality of inquiry data items in natural language from the prompt sentence; and
parse the generated natural language into structured inquiry data objects each having an inquiry identifier, a text field, and a data type classification.

9. The system according to claim 8, wherein normalizing the response data comprises converting raw response values into standardized representations by at least one of format conversion, unit conversion, and mapping to predefined category codes using vector embeddings and cosine similarity.

10. The system according to claim 9, wherein the circuitry is further configured to:
search the data store using indexed fields derived from the standardized representations to retrieve the plurality of candidate data records; and
compute a degree of matching between the standardized representations and attributes of each candidate data record using a scoring function comprising a weighted combination of partial match scores.

11. The system according to claim 10, wherein the circuitry is further configured to:
receive authentication data from an identification medium via the terminal device;
execute a verification process based on the authentication data; and
register transaction data associating verified identity information with the one or more candidate data records in a persistent recording device.

12. The system according to claim 1, wherein the circuitry is further configured to:
receive image data of an identification document captured by an imaging component of the terminal device;
execute character-recognition processing on the image data to extract structured personal data fields;
automatically populate predetermined fields of a transaction data structure with the extracted structured personal data fields; and
transmit the populated transaction data structure to the terminal device for user confirmation and correction.

13. The system according to claim 12, wherein the character-recognition processing comprises applying a convolutional neural network to segmented text regions of the image data, and wherein extracting the structured personal data fields comprises applying a sequence-tagging model that maps recognized text tokens with positional features to semantic field labels.

14. The system according to claim 12, wherein the circuitry is further configured to:
receive a finalization signal from the terminal device; and
update a state indicator of the transaction data structure from a draft state to an active state and persist the transaction data structure to a non-volatile storage device.

15. The system according to claim 1, wherein the circuitry is further configured to:
extract facial feature data from image data captured by an imaging component of the terminal device using a convolutional neural network;
extract acoustic feature data from audio data captured by an audio acquisition component of the terminal device;
combine the facial feature data and the acoustic feature data into a multimodal feature vector; and
classify an emotional state of a user from the multimodal feature vector using an emotion classification model.

16. The system according to claim 15, wherein the circuitry is further configured to adjust a weighting function used to rank the one or more candidate data records based on the classified emotional state, wherein the weighting function increases a simplicity weight when the emotional state indicates confusion and increases a premium weight when the emotional state indicates positive engagement.

17. The system according to claim 16, wherein the circuitry is further configured to construct an emotion-adapted prompt comprising the classified emotional state and the one or more candidate data records, transmit the emotion-adapted prompt to the neural network generative model, and obtain emotion-adjusted explanation data tailored to the classified emotional state.

18. A system comprising:
circuitry configured to:
receive, via a communication interface coupled to a packet-switched network, selection data indicating a classification parameter from a terminal device;
construct a prompt sentence encoding the classification parameter and transmit the prompt sentence to a generative model implemented as a transformer architecture to obtain a plurality of dynamically generated inquiry items in natural language;
transmit the plurality of dynamically generated inquiry items to the terminal device and receive response data from the terminal device;
normalize the response data into structured attribute data and search a data store using the structured attribute data to retrieve candidate data records;
compute a ranking score for each candidate data record based on a matching function applied to the structured attribute data and attributes of each candidate data record;
construct result data comprising the candidate data records ranked by the ranking score and explanation data obtained from the generative model; and
transmit the result data to the terminal device via the communication interface as a structured output document.

19. The system according to claim 18, wherein the circuitry is further configured to:
receive image data of an identification document from the terminal device;
extract personal data fields from the image data via character-recognition processing;
populate a transaction data structure with the extracted personal data fields; and
register the transaction data structure in a persistent storage device responsive to a finalization signal from the terminal device.

20. A method performed by circuitry, the method comprising:
receiving, via a communication interface coupled to a packet-switched network, selection data indicating a classification parameter selected at a terminal device;
retrieving, based on the classification parameter, a plurality of inquiry data items from a data store;
transmitting the plurality of inquiry data items to the terminal device;
receiving response data corresponding to the plurality of inquiry data items from the terminal device;
aggregating and evaluating the response data using a tabular data-processing engine to compute attribute values for candidate data records;
extracting one or more candidate data records satisfying threshold criteria;
constructing a prompt comprising the classification parameter, the response data, and the one or more candidate data records, and transmitting the prompt to a neural network generative model to obtain explanation data;
forming result data by associating the explanation data with the one or more candidate data records; and
converting the result data into a structured output document and transmitting the structured output document to the terminal device.
